(19) United States
(12) Patent Application Publication
(10) Pub. No.: US 2024/0131917 A1
(43) Pub. Date: Apr. 25, 2024

(54) ROBOT WHEEL DRIVING APPARATUS

(71) Applicant: LG ELECTRONICS INC., Seoul (KR)

(72) Inventors: Jangwon LEE, Seoul (KR); Sang Chul HAN, Seoul (KR); Young Il PARK, Seoul (KR)

(21) Appl. No.: 18/239,899

(22) Filed: Aug. 29, 2023

(30) Foreign Application Priority Data
Oct. 23, 2022 (KR) 10-2022-0137757

(51) Int. Cl. B60K 7/00; B60K 11/06; G05D 1/02; H02K 9/06; H02K 11/33; H02K 21/22

(52) U.S. Cl. CPC B60K 7/0007; B60K 11/06; G05D 1/021; H02K 9/06; H02K 11/33; H02K 21/22; B60K 2007/0092; H02K 2211/03

(57) ABSTRACT

A robot wheel driving apparatus comprises: a wheel configured to rotate and move a robot, a motor housing provided inside the wheel and having a cylindrical shape, the motor housing defining an open surface, a motor inserted into the motor housing and configured to provide a rotational force to the wheel, an inverter cover connected to the motor and covering the open surface of the motor housing, and an aluminum electrolytic capacitor protruding from an inside of the inverter cover in a direction opposite to the inverter cover, at least a part of the aluminum electrolytic capacitor being accommodated in the motor.

### CROSS-REFERENCE TO RELATED APPLICATION

This application claims priority to and the benefit of Korean Patent Application No. 10-2022-0137757, filed on Oct. 24, 2022, the disclosure of which is incorporated herein by reference in its entirety.

### BACKGROUND

### 1. Field

Embodiments of the present disclosure relate to a robot wheel driving apparatus, and more specifically, to a robot wheel driving apparatus in which a size and a weight of a robot wheel motor are reduced and an increase in a temperature of an aluminum electrolytic capacitor is prevented while using the aluminum electrolytic capacitor used for a direct current (DC) link of an inverter.

### 2. Description of the Related Art

Contents to be described below are only described for the purpose of providing background information related to embodiments of the present disclosure, and it goes without saying that the described contents do not constitute the related art.

Robots are mechanical devices capable of recognizing an external environment by itself and autonomously operating by determining situations. Depending on the purpose, robots may be classified into industrial robots and service robots.

Until now, the focus has been on the purpose of mechanical utilization rather than a direction of approaching human intelligence, and the robot has been mainly used for factory automation such as doing simple repetitive tasks that are difficult for people to do.

In recent years, with the rapid development of an artificial intelligence technology and increases in levels of Internet of Things (IoT), sensors, and cloud technologies, robots with intelligence different from before are appearing.

Home robots may not only help with daily activities at home while interacting with people and provide entertainment, but also perform various roles such as improving fire, noise, and risk factors.

Meanwhile, various types of devices required for these robots to move are being developed, and representatively, the technology development for driving apparatuses such as a robot wheel motor is being conducted.

For example, robot wheel driving apparatuses may be connected to a leg of a robot and may each use a motor to rotate a wheel equipped with a tire at a set speed. In addition, an inverter motor may be used as the motor used in the robot wheel driving apparatus.

The inverter motor has an advantage in that a rotation speed of the motor can be freely adjusted through power supplied to the motor, unnecessary energy consumption and noise can be significantly reduced, and delicate operations can be implemented.

Meanwhile, in the inverter motor, a multi-layer ceramic capacitor (MLCC) for a direct current (DC) link may be used.

However, the MLCC has an advantage of good high-frequency characteristics, but has a disadvantage of high risk of cracking caused by thermal deformation of a printed circuit board (PCB), and thus a reliability design is required.

In addition, the MLCC is relatively expensive, and since the MLCC has a small capacitance, there is a disadvantage of spatial restrictions in component arrangement because many MLCCs need to be disposed in parallel.

As a method for solving the disadvantages of the MLCC, there has been an attempt to apply an aluminum electrolytic capacitor to an inverter motor.

The aluminum electrolytic capacitor has advantages of low cost and high structural reliability to thermal deformation of the PCB compared to the MLCC.

In addition, since the aluminum electrolytic capacitor may be applied as a single component, there is an advantage in that there is no spatial restrictions upon disposed on the PCB, and thus area efficiency of the PCB is increased.

However, in general, the aluminum electrolytic capacitor is characterized by having a relatively greater height than the MLCC.

In addition, the aluminum electrolytic capacitor is disposed on the PCB and positioned inside an inverter cover.

Therefore, since a size (in particular, a height) of the inverter cover to accommodate the aluminum electrolytic capacitor upon using the aluminum electrolytic capacitor needs to be increased, there has been a problem in that the size and weight of the motor need to be increased. That is, the aluminum electrolytic capacitor has a disadvantage of hindering the miniaturization and light-weight of the motor upon applied to the inverter motor.

In addition, the aluminum electrolytic capacitor has the characteristic of generating heat due to an increase in a resistance component in a high frequency band. Therefore, upon using the aluminum electrolytic capacitor, a device for preventing an increase in temperature is required.

However, in the case of the conventional type, in particular, an inverter-integrated motor in a robot wheel driving apparatus has a sealed structure provided with a wheel cover. In addition, air is inevitably stagnant in an internal space between the inverter cover and the PCB due to the sealed structure therebetween.

Therefore, when the aluminum electrolytic capacitor is disposed between the inverter cover and the PCB, there is a disadvantage in that there is no way to reduce a temperature increased by heating of the aluminum electrolytic capacitor.

Therefore, when the aluminum electrolytic capacitor is applied to the inverter-integrated motor of the robot wheel driving apparatus that requires miniaturization and light-weight, a solution capable of reducing the size and weight of the motor and preventing the increase in temperature is required.

As the related art document related to the present disclosure, Korean Patent Application Laid-Open No. 10-2019-0008609 (hereinafter referred to as “Patent Document 1”) discloses an inverter-integrated motor.

The inverter-integrated motor disclosed in Patent Document 1 includes a motor, an inverter housing of which one side is coupled to the motor, and a PCB coupled to the other side of the inverter housing.

In particular, in the inverter-integrated motor disclosed in Patent Document 1, a capacitor is disposed on an external region of the PCB, a cooling hole is formed in the inverter housing, and the cooling hole is formed to pass through an edge wall surrounding the periphery of the PCB.

As described above, in Patent Document 1, the capacitor is accommodated in the inverter housing in the inverter-integrated motor, and the cooling hole is disposed in the inverter housing, thereby preventing an increase in temperature.

However, in the case of the inverter-integrated motor of Patent Document 1, since the capacitor is accommodated in the inverter housing, when a height of the capacitor is great, a size of the inverter housing is great, thereby increasing a weight of the inverter.

In addition, in the inverter-integrated motor of Patent Document 1, even when the cooling hole is formed in the edge wall surrounding the PCB in the inverter housing, it is difficult for the air that is stagnant inside the inverter housing to smoothly flow through the cooling hole. Therefore, there is the disadvantage in that it is difficult to expect a satisfactory level of cooling efficiency.

As another related art document related to the present disclosure, Japanese Patent Application Laid-Open JP2014-143841A (hereinafter referred to as “Patent Document 2”) discloses an inverter-integrated motor.

The inverter-integrated motor disclosed in Patent Document 2 includes a motor, a motor case, an inverter case, and a capacitor. In addition, in Patent Document 2, heat-radiation fins are provided outside a motor case, and the heat-radiation fins are also provided outside an inverter case. The inverter-integrated motor of Patent Document 2 configured as described above provides a structure that is excellent in heat dissipation without increasing a size of the motor.

However, in the case of the inverter-integrated motor of Patent Document 2, the capacitor is disposed to have a predetermined height inside the inverter case. Therefore, when a component having an increased height such as an aluminum electrolytic capacitor is used, a size of the inverter case needs to be increased, thereby increasing a weight of the motor.

In addition, in the case of the inverter-integrated motor of Patent Document 2, the heat-radiation fins are formed outside the inverter case, but there is the disadvantage in that the heat dissipation effect is not great because air is stagnant in an internal sealed space of the inverter case.

That is, Patent Document 2 does not suggest a configuration of generating air flow to more effectively cool a component heated by an increase in a resistance component in a high frequency band, such as the aluminum electrolytic capacitor. Therefore, it is difficult to prevent the increase in the temperature of the aluminum electrolytic capacitor.

As still another related art document related to the present disclosure, U.S. patent Ser. No. 11/411,523 B2 (hereinafter referred to as “Patent Document 3”) discloses a motor driving apparatus including a plurality of capacitors.

The motor driving apparatus disclosed in Patent Document 3 includes at least one smoothing capacitor and a snubber capacitor.

However, the motor driving apparatus disclosed in Patent Document 3 does not specifically suggest an improvement method for achieving miniaturization and light-weight of a motor through an arrangement direction and coupling structure of the capacitor. In addition, the motor driving apparatus disclosed in Patent Document 3 does not suggest an improvement method for preventing an increase in temperature caused by heating of the capacitor at all.

### RELATED ART DOCUMENTS

### Patent Documents

(Patent Document 1) Korean Patent Application Laid-Open No. 10-2019-0008609
(Patent Document 2) Japanese Patent Application Laid-Open JP2014-143841A
(Patent Document 3) U.S. patent Ser. No. 11/411,523 B2

### SUMMARY

The present disclosure is directed to providing a robot wheel driving apparatus in which a size and weight of the entire motor are prevented from being increased due to an increase in a height of an aluminum electrolytic capacitor and the miniaturization and light-weight of the apparatus are achieved using the aluminum electrolytic capacitor for a direct current (DC) link in an inverter-integrated motor.

The present disclosure is directed to providing a robot wheel driving apparatus in which an aluminum electrolytic capacitor is disposed in a direction opposite to an inverter cover (i.e., a direction toward the inside of a motor) in consideration of the characteristics that the aluminum electrolytic capacitor is heated by an increase in a resistance component in a high frequency band and at the same time, a fan is applied to a rotor to generate air flow so as to prevent an increase in a temperature of the aluminum electrolytic capacitor.

The present disclosure is directed to providing a robot wheel driving apparatus of which durability that may allow an insulation distance between an aluminum electrolytic capacitor and a motor component to be sufficiently secured is increased and stability in use is improved.

Objects of the present disclosure are not limited to the above-described objects, and other objects and advantages of the present disclosure that are not mentioned can be understood by the following description and more clearly understood by embodiments of the present disclosure. In addition, it will be able to be easily seen that the objects and advantages of the present disclosure may be achieved by devices and combinations thereof that are described in the claims.

According to one aspect of the present disclosure, there may be provided a robot wheel driving apparatus in which a size and weight of the entire motor are prevented from being increased due to an increase in a height of an aluminum electrolytic capacitor upon using the aluminum electrolytic capacitor for a DC link in an inverter-integrated motor.

The robot wheel driving apparatus according to one embodiment of the present disclosure includes a wheel, a motor housing, a motor, an inverter cover, and an aluminum electrolytic capacitor.

The wheel may have a circular body that rotates to drive a robot.

The motor housing may be provided inside the wheel and may have a cylindrical shape with one open surface. The motor housing includes a disk-shaped first motor housing portion that may be seated inside the wheel, and a circular tube-shaped second motor housing portion that may be in close contact with an inner circumferential surface of the wheel.

A through hole having a predetermined diameter and formed to pass through the first motor housing portion in a thickness direction may be provided at the center of the first motor housing portion. The through hole may be used as a portion into which a rear end of a rotational shaft (specifically, a second rotational shaft portion) of a rotor frame is inserted. The rotational shaft of the rotor frame may be inserted through the through hole and then connected to a fastening hole of the wheel, and as a bolt sequentially fastens the fastening hole of the wheel and a fastening groove of the rotational shaft, the rotational shaft of the rotor frame and a center of the wheel may be firmly connected.

The motor may be inserted into the motor housing and provide a rotating force to the wheel. Here, the motor may be an inverter-integrated motor.

The inverter cover may have a shape that covers the one open surface of the motor housing. The inverter cover may be connected to the motor in an integrated structure.

The aluminum electrolytic capacitor may be disposed to protrude from the inside of the inverter cover in a direction opposite to the inverter cover (i.e., a direction toward an inside of the motor). At least a part of the aluminum electrolytic capacitor may be accommodated in an empty space inside the motor and used for an inverter direct current (DC) link.

The aluminum electrolytic capacitor may have a predetermined height. When the aluminum electrolytic capacitor protrudes in a direction toward the inverter cover, there is a disadvantage in that a height of the inverter cover, which is a size, increases, and a weight of the inverter cover increases. Therefore, the aluminum electrolytic capacitor may be accommodated using a remaining space inside the motor by protruding in the direction opposite to the inverter cover (i.e., the direction toward the inside of the motor). Therefore, it is possible to miniaturize the size of the inverter-integrated motor and reduce the weight thereof.

The robot wheel driving apparatus according to one embodiment of the present disclosure may further include a printed circuit board (PCB).

The PCB may be provided inside the inverter cover and disposed to face the motor.

The aluminum electrolytic capacitor may be disposed on one surface facing the motor between both surfaces of the PCB.

The aluminum electrolytic capacitor may protrude toward an empty space inside the motor at a position spaced a predetermined distance from a center of the motor in a radial direction.

The motor may include a stator fixed inside the motor housing, and a rotor disposed outside the stator with an air gap interposed therebetween and configured to rotate about the stator. In this case, the rotor may include a fan configured to cool heat generated in the aluminum electrolytic capacitor.

The motor may include a stator fixed inside the motor housing, and a rotor disposed outside the stator with an air gap interposed therebetween and configured to rotate about the stator. In this case, the rotor may have a fan configured to cool the heat generated in the aluminum electrolytic capacitor. The fan may include a first fan and a second fan. The first fan may be positioned inside the rotor in a radial direction and may rotate with the rotor to cool the aluminum electrolytic capacitor. The second fan may be positioned outside the rotor in the radial direction at a predetermined distance from the first fan and configured to rotate with the rotor to cool the aluminum electrolytic capacitor.

The aluminum electrolytic capacitor may be disposed so that at least a part thereof is accommodated in the empty space inside the motor provided between the first fan and the second fan. In this case, a first insulation distance may be formed between the aluminum electrolytic capacitor and the first fan. In addition, a second insulation distance may be formed between the aluminum electrolytic capacitor and the second fan.

The motor may include a stator fixed inside the motor housing, a rotor disposed outside the stator with an air gap interposed therebetween and configured to rotate about the stator, and a fan for cooling the heat generated in the aluminum electrolytic capacitor.

In this case, the stator may include a plurality of coils disposed in a circumferential direction, and a stator core on which the plurality of coils are wound and mounted.

In this case, the rotor may include a plurality of magnets disposed to face the plurality of coils in a circumferential direction, and a rotor frame configured to fix the plurality of magnets, connected concentrically to the wheel, and configured to rotate inside the motor housing.

In this case, the fan may be formed on the rotor frame.

The rotor frame may include a rotational shaft formed in a central direction of the motor.

The rotational shaft may include a first rotational shaft portion and a second rotational shaft portion.

The first rotational shaft portion may be supported by a first bearing.

The second rotational shaft portion may have a greater diameter than the first rotational shaft portion and may be connected integrally with a rear end of the first rotational shaft portion and supported by a second bearing.

In addition, a wave washer may be provided at a front end of the first bearing.

The rotor frame may include the rotational shaft formed in the central direction of the motor, a disk-shaped first rotor frame portion connected to the rotational shaft, and a circular tube-shaped second rotor frame portion protruding to a predetermined length from an edge of the first rotor frame portion.

In this case, the fan may be formed on the first rotor frame portion.

The rotor frame may include the rotational shaft formed in the central direction of the motor, a disk-shaped first rotor frame portion connected to the rotational shaft, and a circular tube-shaped second rotor frame portion protruding to a predetermined length from an edge of the first rotor frame portion.

In this case, the first rotor frame portion may include an outer frame, an inner frame, and an inclined frame.

The outer frame may be a disk-shaped frame formed at a position far from the center of the motor in a radial direction.

The inner frame may be a disk-shaped frame formed at a position close to a center of the motor in the radial direction and connected (i.e., connected to have different heights) to the outer frame with a step therebetween.

The inclined frame may connect the outer frame to the inner frame.

In this case, the fan may include a first fan and a second fan, and the first fan may be formed on the inner frame to cool the aluminum electrolytic capacitor. In addition, the second fan may be formed on the inclined frame and may cool the aluminum electrolytic capacitor.

The first fan may be formed on the inner frame and may be disposed radially with respect to a rotational shaft. The first fan may rotate with the rotor frame to generate air flow to cool the aluminum electrolytic capacitor, thereby preventing an increase in a temperature of the aluminum electrolytic capacitor.

The second fan may be formed on the inclined frame and disposed radially with respect to the rotational shaft. The second fan may rotate with the rotor frame to generate air flow, and when the first fan and the second fan rotate simultaneously at different positions, it is possible to more effectively prevent the increase in the temperature of the aluminum electrolytic capacitor.

That is, the first fan may rotate close to a side surface of the aluminum electrolytic capacitor and the second fan may rotate close to the protruding front end of the aluminum electrolytic capacitor, thereby improving a function of preventing the increase in the temperature of the aluminum electrolytic capacitor.

The first fan may protrude to a first set height in an axial direction. The second fan may protrude to a second set height in the axial direction. In this case, the second fan may protrude higher than the first fan. For example, the first set height of the first fan may be 3 mm. The second set height of the second fan may be 7 mm.

The first fan may have a rectangular wing shape having a first set length in a radial direction of the motor.

The second fan may have a right-angled triangle wing shape having a second set length in the radial direction of the motor. In this case, the second fan may be formed to be longer than the first fan. For example, the first set length of the first fan may be 7 mm, and the second set length of the second fan may be 12 mm.

Since air may flow from the inside to the outside and from the top to the bottom of the rotational shaft by the rotation of the first fan and the second fan, it is advantageous for heat exchange of the aluminum electrolytic capacitor protruding close to the first fan and the second fan, and it is possible to prevent the increase in the temperature of the aluminum electrolytic capacitor.

The aluminum electrolytic capacitor is characterized by an increase in heat generation and an increase in temperature due to an increase in resistance in a high frequency band. When the aluminum electrolytic capacitor has a structure protruding toward the inverter cover, air is stagnant in the space between the inverter cover and the PCB, and thus it is not possible to prevent the increase in the temperature of the aluminum electrolytic capacitor. That is, when the aluminum electrolytic capacitor is disposed on one surface facing the inverter cover between both surfaces of the PCB, it is not possible to prevent the increase in the temperature of the aluminum electrolytic capacitor.

The robot wheel driving apparatus according to the embodiment of the present disclosure has a structure in which the aluminum electrolytic capacitor is disposed to protrude toward the empty space inside the motor. Therefore, when the rotor (specifically, the rotor frame) rotates, the first fan and the second fan simultaneously rotate to generate air flow for preventing the increase in the temperature of the aluminum electrolytic capacitor.

The first fan is formed on the inner frame and positioned inside the motor in the radial direction, and the second fan is formed on the inclined frame and positioned outside the motor in the radial direction. Shapes of the first fan and the second fan are not necessarily limited to the rectangular wing shape and may have various other modified examples.

The aluminum electrolytic capacitor may be disposed so that at least a part thereof is accommodated in the empty space inside the motor provided between the first fan and the second fan. In this case, a first gap portion may be formed between the aluminum electrolytic capacitor and the first fan. In this case, a second gap portion may be formed between the aluminum electrolytic capacitor and the second fan.

A protrusion of the aluminum electrolytic capacitor may be accommodated in the empty space between the rotational shaft and the plurality of coils.

The first gap portion and the second gap portion may have a distance of at least 1.5 mm.

The first gap portion may be a separation space between the necessary capacitor and the first fan.

Since the first gap portion may have a distance of at least 1.5 mm, it is possible to secure an insulation distance required between the aluminum electrolytic capacitor and the first fan. As a result, it is possible to prevent damage and lifetime shortening of the aluminum electrolytic capacitor and improve the stability and reliability in use of the robot wheel driving apparatus.

The second gap portion may be a separation space between the aluminum electrolytic capacitor and the second fan.

Since the second gap portion may have a distance of at least 1.5 mm, it is possible to secure a necessary insulation distance between the aluminum electrolytic capacitor and the second fan. As a result, it is possible to prevent damage and lifetime shortening of the aluminum electrolytic capacitor and improve the stability and reliability in use of the robot wheel driving apparatus.

A sensor magnet may be coupled to the rotational shaft. The sensor magnet may be coupled to a front end of the first rotational shaft portion. The sensor magnet may be positioned to face an encoder sensor disposed on the PCB at a set distance. Therefore, the encoder sensor disposed on the PCB may detect the number of rotations of the motor by detecting the sensor magnet coupled to the front end of the first rotational shaft portion.

A fastening groove to which a bolt may be fastened is provided at a rear end of the rotational shaft, that is, a rear end of the second rotational shaft portion.

The fastening groove may be positioned at the center of the motor and connected to a fastening hole formed to pass through the center of the wheel. Therefore, the bolt may be fastened by passing through the fastening hole of the wheel and then inserted into and fastened to the fastening groove positioned at the rear end of the rotational shaft. Therefore, the wheel and the rotor frame may be concentrically coupled. When the rotor frame rotates within the motor housing, a rotating force may be transmitted to the wheel coupled concentrically to the rotor frame so that the rotation of the wheel required for the robot to travel may be possible.

The rotor frame may include the rotational shaft formed in the central direction of the motor, a disk-shaped first rotor frame portion connected to the rotational shaft, and a circular tube-shaped second rotor frame portion protruding to a predetermined length from an edge of the first rotor frame portion. In this case, the fan may be formed on the first rotor frame portion. The first rotor frame portion may have a plurality of holes formed to pass therethrough in a thickness direction at a position away from the fan.

The plurality of holes may be formed in a body portion on which no first fan and second fan are formed in the first rotor frame portion having a disk-shaped body and formed to pass through the first rotor frame portion in the thickness direction. For example, the plurality of holes may be six and radially formed to be spaced a predetermined distance from each other with respect to the center of the motor.

The fan may be formed on the first rotor frame portion to rotate with the first rotor frame portion and generate air flow used to cool the aluminum electrolytic capacitor. In addition, the plurality of holes may be formed in a region in which no fan is formed in the first rotor frame portion and used as a space for the air flow necessary for cooling the aluminum electrolytic capacitor together with the fan. In addition, the plurality of holes can reduce the weight of the first rotor frame portion to reduce the weight of the entire motor.

The robot wheel driving apparatus according to the embodiment of the present disclosure includes a PCB provided inside the inverter cover and disposed to face the motor. The motor includes a stator fixed inside the motor housing, a rotor disposed outside the stator with an air gap interposed therebetween and configured to rotate about the stator, and a fan for cooling heat generated in the aluminum electrolytic capacitor. The stator includes a plurality of coils disposed in a circumferential direction, a stator core on which the plurality of coils are wound and mounted, and a stator frame configured to support the stator.

In this case, one surface of the stator frame may be coupled to the motor housing to cover the one open surface of the motor housing, and the inverter cover may cover and be coupled to the other surface of the stator frame. The PCB may be fastened to the stator frame and fixedly positioned inside the inverter cover.

The stator frame may include a first stator frame portion, a second stator frame portion, and a third stator frame portion.

The first stator frame portion may circularly protrude to face the center of the motor.

The second stator frame portion may circularly protrude to a distance in the radial direction from the first stator frame portion.

The third stator frame portion may radially connect the first stator frame portion to the second stator frame portion.

The PCB may be fastened to the second stator frame portion.

A third gap portion may be formed between the aluminum electrolytic capacitor and the third stator frame portion. For example, the third gap portion may have a distance of at least 1.5 mm. The third gap portion may be an insulation distance required between the aluminum electrolytic capacitor and the third stator frame portion, and as the third gap portion is formed, it is possible to prevent damage and lifetime shortening of the aluminum electrolytic capacitor and improve the stability and reliability in use of the robot wheel driving apparatus.

A cylindrical groove may be formed at the center of the first stator frame portion, and a front end of the first rotational shaft portion of the rotational shaft may be inserted into and supported by the cylindrical groove.

A first bearing may be inserted between the cylindrical groove and the front end of the first rotational shaft portion.

The first bearing may reduce rotational friction of the first rotational shaft portion and support the first rotational shaft portion.

The second rotational shaft portion may be supported by a second bearing.

The motor housing may include a disk-shaped first motor housing portion and a circular tube-shaped second motor housing portion protruding to a set length from an edge of the first motor housing portion, and a through hole may be provided at the center of the first motor housing portion.

The motor housing may have a cylindrical support groove around the through hole.

The support groove may be used as a region into which the second bearing is inserted.

The second bearing may be constrained to the support groove and disposed between the second rotational shaft portion passing through the through hole and the motor housing.

The second bearing may reduce rotational friction of the second rotational shaft portion and support the second rotational shaft portion.

The second stator frame portion may include a circular protrusion protruding toward the motor.

The circular protrusion may protrude to the inside of the motor and have a structure in which an outer circumferential surface of the protrusion and an inner circumferential surface of the stator core are in close contact with each other. Therefore, the second stator frame portion may firmly support the stator, particularly, the stator core.

The second stator frame portion may include a plurality of PCB fastening portions. The plurality of PCB fastening portions may be portions to which a plurality of bolts passing through the PCB are screw-coupled and may firmly fix the PCB.

According to another aspect of the present disclosure, there may be provided a robot wheel driving apparatus, which applies an aluminum electrolytic capacitor for an inverter DC link to solve disadvantages of a multi-layer ceramic capacitor (MLCC), thereby reducing a size and weight of a motor and preventing an increase in temperature to improve stability and reliability in use.

The robot wheel driving apparatus according to one embodiment of the present disclosure includes a wheel, a wheel cover, a lower cover, a motor housing, a motor, an inverter cover, and an aluminum electrolytic capacitor.

The wheel may have a circular body configured to rotate with a tire coupled thereto to drive a robot.

The wheel cover may be connected to the wheel to cover both sides of the wheel.

The lower cover may be coupled to a lower portion of the wheel cover. The lower cover may be coupled to an open portion of the wheel cover to cover an open portion between the tire exposed to the lower portion of the wheel and the wheel cover when the wheel and the wheel cover are connected. Therefore, it is possible to prevent foreign substances outside the wheel from flowing into the wheel.

In addition, the motor housing may be provided inside the wheel and may have a cylindrical shape with one open surface. The motor may be inserted into the motor housing and may provide a rotating force to the wheel. The inverter cover may be connected to the motor to cover the open one side of the motor housing. The aluminum electrolytic capacitor may be disposed to protrude from the inner side of the inverter cover in a direction opposite to the inverter cover, and at least a part of the aluminum electrolytic capacitor may be accommodated in the motor to be used for an inverter DC link.

The wheel may include a disk-shaped first wheel body portion and a second wheel body portion protruding in a circular tube shape along an edge of the first wheel body portion and equipped with a tire.

The wheel cover may include a first wheel cover portion configured to cover one side of the wheel, a second wheel cover portion coupled to face the first wheel cover portion with the wheel interposed therebetween and configured to cover the other side of the wheel, and a leg connector connecting the first wheel cover portion and the second wheel cover portion to a robot body.

The first wheel cover portion may include a first cover body having a shape that convexly covers one side of the wheel in order to secure a first internal space having a predetermined size between the first wheel cover portion and the one side of the wheel, and a first connector extending from an upper end of the first cover body in a height direction and connecting the first cover body to the leg connector.

The second wheel cover portion may include a second cover body having a shape that convexly covers the other side of the wheel in order to secure a second internal space having a predetermined size between the second wheel cover portion and the other side of the wheel, and a second connector extending from an upper end of the second cover body in the height direction and connecting the second cover body to the leg connector.

The robot wheel driving apparatus according to one embodiment of the present disclosure may further include a link.

The link may be embedded in the wheel cover and may connect the motor to the wheel cover to constrain a position of the motor.

One end of the link may be fixed to the wheel cover, and the other end of the link may be fixed to the motor.

For example, the one end of the link may be a straight link portion, and the other end of the link may be a circular link portion.

The straight link portion may be fixed inside at least one of the first and second connectors.

The circular link portion may be connected to a lower end of the straight link portion and fixed to the motor.

In addition, the circular link portion may be fixedly bolt-fastened to a stator frame, and the inverter cover protruding in a circular cap shape may be positioned in an internal hollow of the circular link portion.

A fastening groove may be provided in an inner circumferential surface of the tire. In addition, a fastening protrusion inserted into the fastening groove may be provided on an outer circumferential surface of the second wheel body portion.

The fastening protrusion may include a band-shaped first fastening protrusion surrounding an outer circumferential surface of the second wheel body portion in a circumferential direction, and a plurality of second fastening protrusions protruding in a direction intersecting the first fastening protrusion and formed at a predetermined distance.

The robot wheel driving apparatus according to one embodiment of the present disclosure may include a PCB provided inside the inverter cover and disposed to face the motor. In this case, the aluminum electrolytic capacitor may be disposed on one surface facing the motor between both surfaces of the PCB.

The aluminum electrolytic capacitor may protrude toward an empty space inside the motor at a position spaced a predetermined distance from a center of the motor in a radial direction.

The motor may include a stator fixed inside the motor housing, and a rotor disposed outside the stator with an air gap interposed therebetween and configured to rotate about the stator. In this case, the rotor may be fastened to the wheel. In addition, the rotor may include a fan configured to cool heat generated in the aluminum electrolytic capacitor.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a front perspective view schematically illustrating a robot wheel driving apparatus according to one embodiment of the present disclosure;

FIG. 2 is a rear perspective view schematically illustrating the robot wheel driving apparatus according to one embodiment of the present disclosure;

FIG. 3 is a left side view schematically illustrating the robot wheel driving apparatus according to one embodiment of the present disclosure;

FIG. 4 is a right side view schematically illustrating the robot wheel driving apparatus according to one embodiment of the present disclosure;

FIG. 5 is a front view schematically illustrating the robot wheel driving apparatus according to one embodiment of the present disclosure;

FIG. 6 is an exploded perspective view schematically illustrating the robot wheel driving apparatus according to one embodiment of the present disclosure;

FIG. 7 is an exploded perspective view schematically illustrating a wheel cover, a wheel, a motor housing, a motor, an inverter cover, and a printed circuit board (PCB) of the robot wheel driving apparatus according to one embodiment of the present disclosure;

FIG. 8 is a cross-sectional view schematically illustrating the entire structure of the robot wheel driving apparatus according to one embodiment of the present disclosure;

FIG. 9 is a perspective view schematically illustrating the wheel cover in the robot wheel driving apparatus according to one embodiment of the present disclosure;

FIG. 10 is a perspective view schematically illustrating a first wheel cover portion in the robot wheel driving apparatus according to one embodiment of the present disclosure;

FIG. 11 is a perspective view schematically illustrating a second wheel cover portion in the robot wheel driving apparatus according to one embodiment of the present disclosure;

FIG. 12 is a left side view illustrating a left internal structure in which the first wheel cover portion is removed from the robot wheel driving apparatus according to one embodiment of the present disclosure;

FIG. 13 is a right side view illustrating a right internal structure in which the second wheel cover portion is removed from the robot wheel driving apparatus according to one embodiment of the present disclosure;

FIG. 14 is a perspective view illustrating a detailed configuration of a tire, a wheel, and a motor in a structure in which the wheel cover is removed from the robot wheel driving apparatus according to one embodiment of the present disclosure;

FIG. 15 is a perspective view illustrating a detailed configuration of the wheel and the motor in a structure in which the tire is removed from FIG. 14;

FIG. 16 is a perspective view illustrating a detailed configuration of the motor in a structure in which the wheel is removed from FIG. 15;

FIG. 17 is a cross-sectional view illustrating an internal structure of a motor when an aluminum electrolytic capacitor is disposed to protrude toward an inverter cover;

FIG. 18 is a cross-sectional view illustrating an internal structure of a motor when the aluminum electrolytic capacitor is disposed to protrude in a direction opposite to the inverter cover according to one embodiment of the present disclosure;

FIG. 19 is a partial perspective view schematically illustrating the motor in the robot wheel driving apparatus according to one embodiment of the present disclosure;

FIG. 20 is a partial perspective view schematically illustrating a rotor frame in the robot wheel driving apparatus according to one embodiment of the present disclosure;

FIG. 21 is a cross-sectional view schematically illustrating the rotor frame in the robot wheel driving apparatus according to one embodiment of the present disclosure;

FIG. 22 is a plan view schematically illustrating the rotor frame in the robot wheel driving apparatus according to one embodiment of the present disclosure;

FIG. 23 is a cross-sectional view illustrating a structure in which a first gap portion and a second gap portion are formed in the robot wheel driving apparatus according to one embodiment of the present disclosure;

FIG. 24 is a view illustrating a structure in which a third gap portion is formed in the robot wheel driving apparatus according to one embodiment of the present disclosure;

FIG. 25 is a comparative cross-sectional view for describing the effect of reducing a size of a motor when the robot wheel driving apparatus according to one embodiment of the present disclosure is applied; and

FIG. 26 is a temperature saturation comparison graph of the robot wheel driving apparatus according to one embodiment of the present disclosure and an existing comparative example.

### DETAILED DESCRIPTION

The above-described objects, features, and advantages will be described below in detail with reference to the accompanying drawings, and thus those skilled in the art to which the present disclosure pertains will be able to easily carry out the technical spirit of the present disclosure. In describing the present disclosure, when it is determined that a detailed description of the known technology related to the present disclosure may unnecessarily obscure the gist of the present disclosure, a detailed description thereof will be omitted. Hereinafter, exemplary embodiments according to the present disclosure will be described in detail with reference to the accompanying drawings. In the drawings, the same reference numerals are used to indicate the same or similar components.

Although the terms first, second, and the like are used to describe various components, it goes without saying that these components are not limited by these terms. These terms are only used to distinguish one component from another component, and unless otherwise stated, it goes without saying that the first component may also be the second component.

Throughout the specification, unless otherwise stated, each component may be singular or plural.

Hereinafter, the arrangement of an arbitrary component on an “upper portion (or lower portion)” of a component or “above (or under)” the component may not only mean that the arbitrary component is disposed in contact with an upper surface (or a lower surface) of the component, but also mean that other components may be interposed therebetween the component and the arbitrary component disposed above (or under) the component.

In addition, when a certain component is described as being “connected,” “coupled,” or “joined” to another component, the components may be directly connected or joined, but it should be understood that other components may be “interposed” between the components, or the components may be “connected,” “coupled,” or “joined” through another component.

The singular expression used herein includes the plural expression unless the context clearly dictates otherwise. In the application, terms such as “composed of” or “comprising” should not be construed as necessarily including all of the various components or operations described in the specification and should be construed as not including some of the components or some of the operations or further including additional components or operations.

Throughout the specification, when “A and/or B” is described, this means A, B, or A and B unless otherwise specified, and when “C to D” is described, this means C or more and D or less unless otherwise specified.

In the following description, a robot is a robot capable of moving in forward, rearward, leftward, and rightward directions by driving a wheel.

In the following description, a robot wheel driving apparatus may be connected to a leg of a robot body and uses a motor to rotate a wheel equipped with a tire at a set speed.

In the following description, the motor used in the robot wheel driving apparatus may be an inverter-integrated motor. In the inverter-integrated motor, a rotation speed of the motor can be freely adjusted through power supplied to the motor, unnecessary energy consumption and noise can be significantly reduced, and delicate operations can be implemented.

In the following description, an aluminum electrolytic capacitor may be used for a direct current (DC) link of the inverter-integrated motor. A multi-layer ceramic capacitor (MLCC) has an advantage of good high-frequency characteristics, but has a disadvantage of high risk of cracking caused by thermal deformation of a printed circuit board (PCB). In addition, the MLCC is a relatively high price, and since the MLCC has a small capacitance, there is a disadvantage of spatial restrictions in component arrangement because many MLCCs need to be disposed in parallel.

Therefore, in order to solve the disadvantages of the MLCC, in the present disclosure, the aluminum electrolytic capacitor may be used.

The aluminum electrolytic capacitor has advantages of low cost and high structural reliability against thermal deformation of the PCB compared to the MLCC.

Since the aluminum electrolytic capacitor may be applied as a single component, there is an advantage in that there is no spatial restrictions upon disposed on the PCB, thereby increasing area efficiency of the PCB.

Hereinafter, the present disclosure will be described in detail with reference to the accompanying drawings illustrating a robot wheel driving apparatus according to an embodiment of the present disclosure.

[Overall Structure of Robot Wheel Driving Apparatus]

Hereinafter, the overall structure of the robot wheel driving apparatus according to one embodiment of the present disclosure will be described in detail with reference to the accompanying drawings.

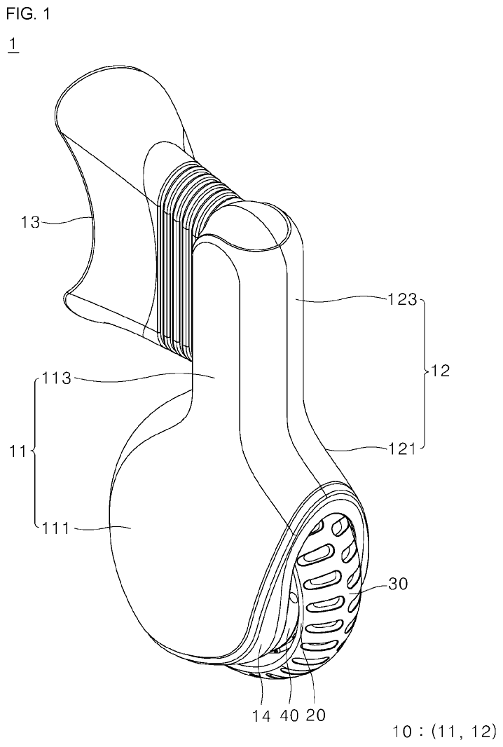

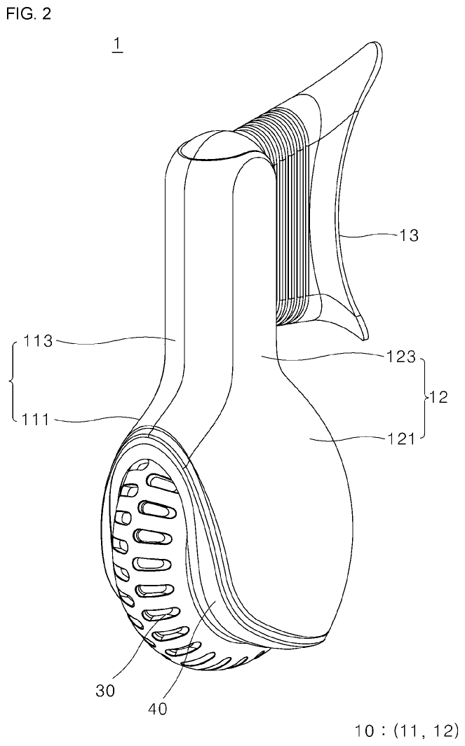

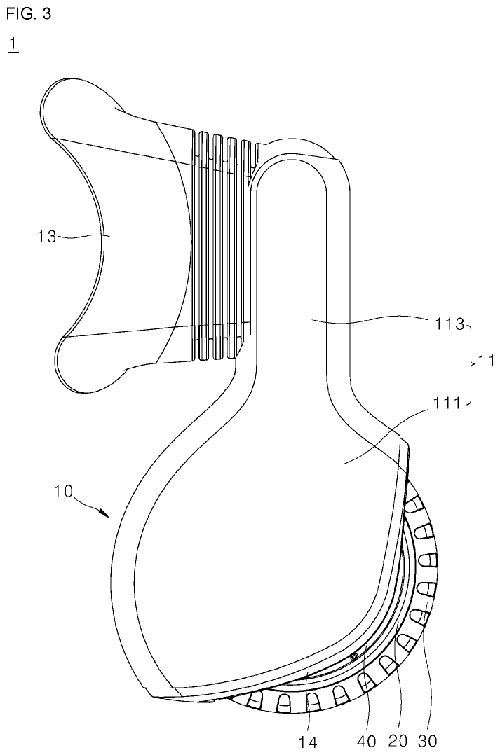

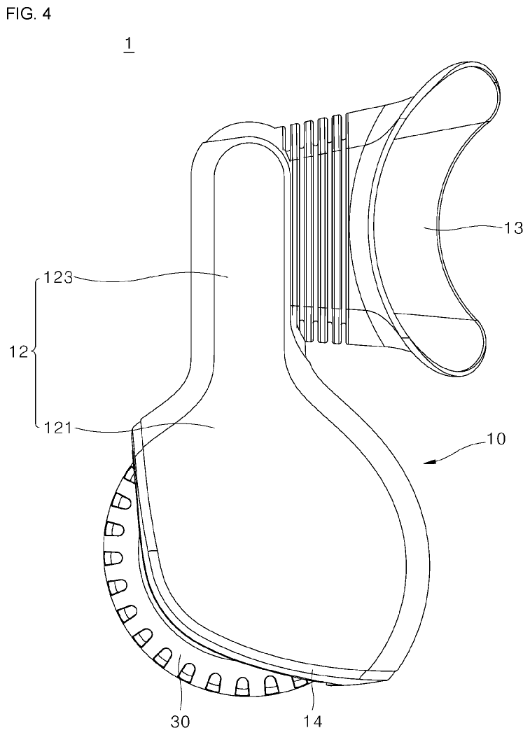

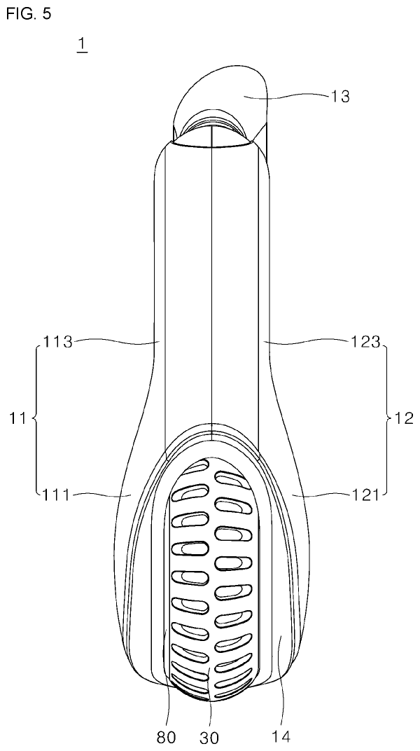

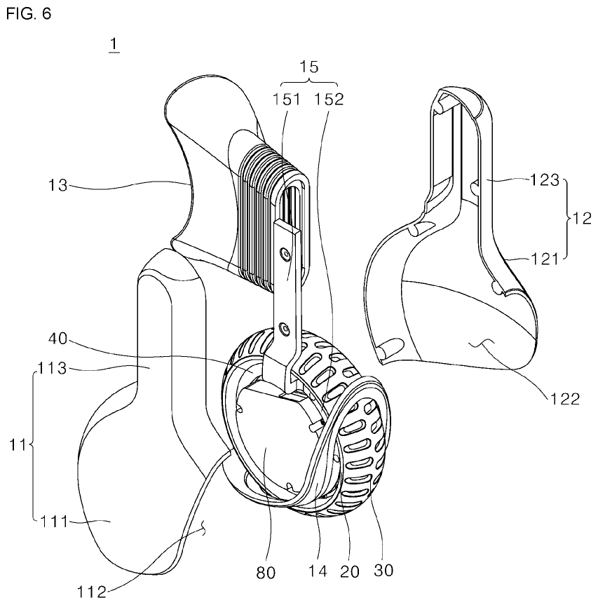

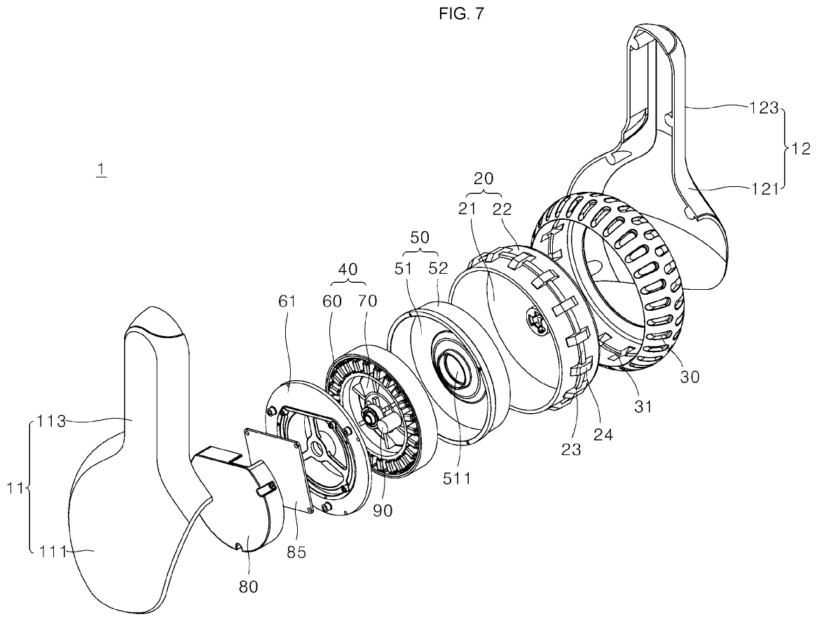

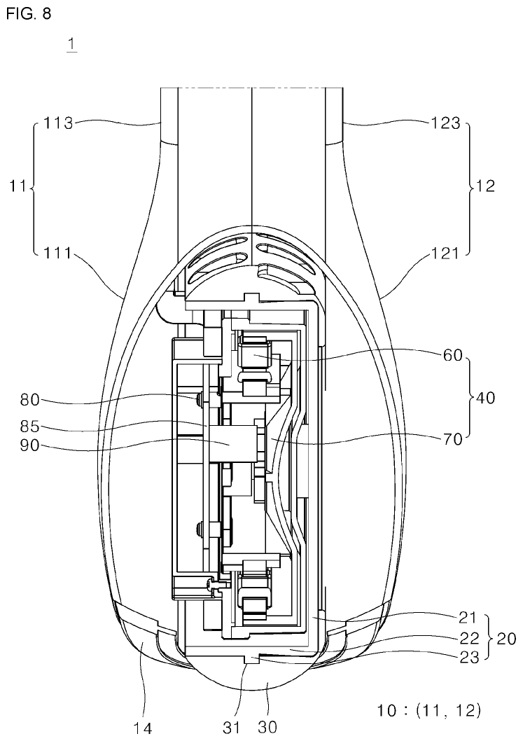

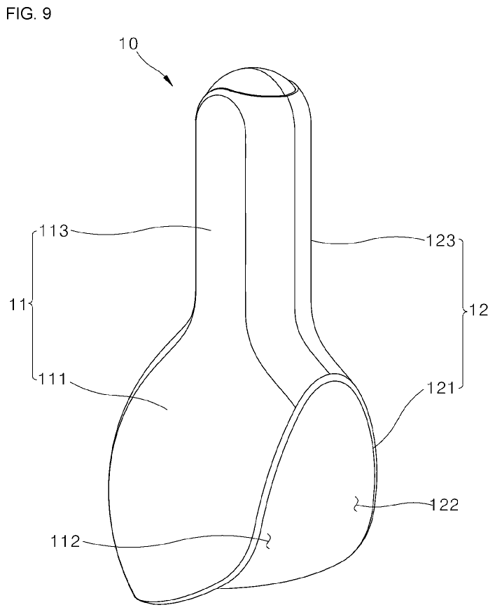

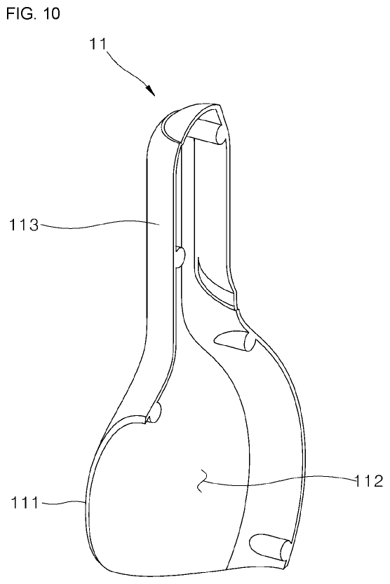

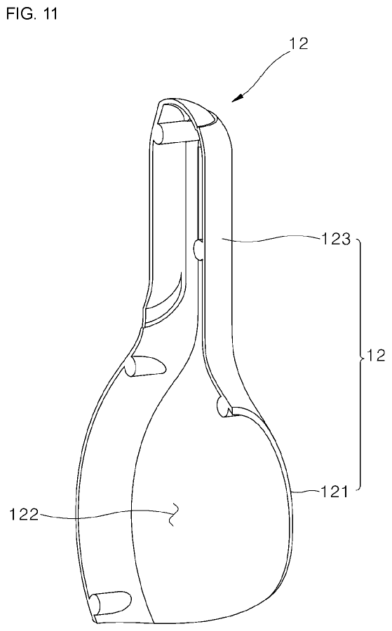

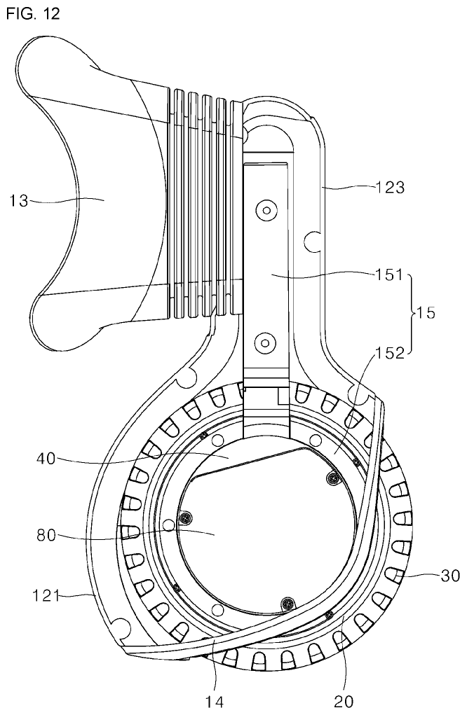

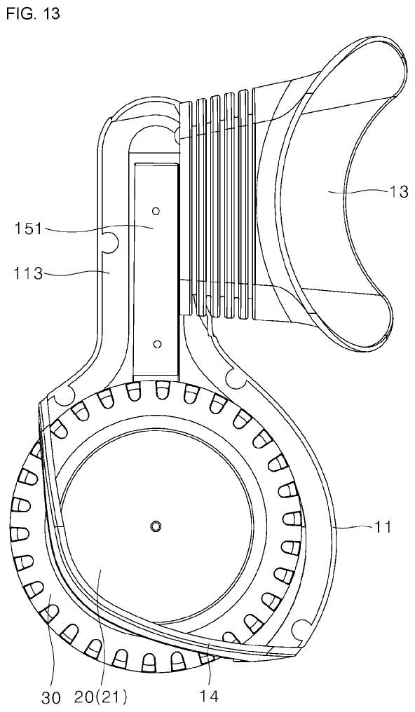

FIGS. 1 to 5 are a front perspective view, a rear perspective view, a left side view, a right side view, and a front view schematically illustrating the entire structure of the robot wheel driving apparatus. In addition, FIGS. 6 and 7 are exploded views illustrating the entire structure of the robot wheel driving apparatus. FIG. 8 is a cross-sectional view illustrating the entire structure of the robot wheel driving apparatus, and FIGS. 9 to 11 are perspective views illustrating a wheel cover, a first wheel cover portion, and a second wheel cover portion. FIG. 12 is a view illustrating a left internal structure of the robot wheel driving apparatus with the first wheel cover portion removed, and FIG. 13 is a view illustrating a right internal structure of the robot wheel driving apparatus with the second wheel cover portion removed.

As illustrated, a robot wheel driving apparatus 1 according to the embodiment of the present disclosure includes a wheel cover 10, a wheel 20, a tire 30, a motor 40, a motor housing 50, an inverter cover 80, a PCB 85, and an Aluminum electrolytic capacitor 90.

The wheel cover 10 has a shape of covering both sides of the wheel 20 and is connected to the wheel 20.

As a specific example, the wheel cover 10 includes a first wheel cover portion 11 and a second wheel cover portion 12 (see FIGS. 9 to 11).

The first wheel cover portion 11 may cover one side (e.g., a left side) of the wheel 20.

The second wheel cover portion 12 may cover the other side (e.g., a right side) of the wheel 20.

The first wheel cover portion 11 and the second wheel cover portion 12 may have the same shape to be symmetrical to each other with respect to the wheel 20.

The second wheel cover portion 12 may be coupled to the first wheel cover portion 11 to face the first wheel cover portion 11 with the wheel 20 interposed therebetween and may cover the other side (e.g., the right side) of the wheel 20.

The wheel cover 10 further includes a leg connector 13.

The leg connector 13 is a portion connecting the first wheel cover portion 11 and the second wheel cover portion 12 to a robot body (not illustrated).

As a specific example, the first wheel cover portion 11 includes a first cover body 111 and a first connector 113.

The first cover body 111 may have a hemispherical cap shape that convexly covers the one side (e.g., the left side) of the wheel 20 to secure a first internal space 112 having a predetermined size between the one side (e.g., the left side) of the wheel and the first cover body 111.

The first connector 113 may have a shape straightly extending from an upper end of the first cover body 111 in a height direction. The first connector 113 connects the first cover body 111 to the leg connector 13.

As a specific example, the second wheel cover portion 12 includes a second cover body 121 and a second connector 123.

The second cover body 121 may have a shape that convexly covers the other side (e.g., the right side) of the wheel 20 to secure a second internal space 122 having a predetermined size between the other side (e.g., the right side) of the wheel 20 and the second cover body 121.

The second connector 123 may have a shape straightly extending from an upper end of the second cover body 121 in the height direction. The second connector 123 connects the second cover body 121 with the leg connector 13.

In addition, a corrugated shape may be provided on a portion in which the first connector 113 and the second connector 123 are connected to the leg connector 13, and an impact at the connection portion may be buffered or the stretch and elongation of the connection portion may be possible using the corrugated shape.

A lower cover 14 may be further provided at a lower end of the wheel cover 10.

The lower cover 14 is coupled to the wheel cover 10 to cover an open lower region of the wheel cover 10.

The lower cover 14 is coupled to cover an open portion between the tire 30 exposed to a lower portion of the wheel 20 and the wheel cover 10 when the wheel 20 and the wheel cover 10 are connected.

The lower cover 14 prevents external bulky foreign substances from flowing into the wheel 20 to damage the motor 40. Therefore, it is possible to improve durability of the robot wheel driving apparatus 1 and improve stability and product reliability in use.

A link 15 may be further provided inside the wheel cover 10 (see FIGS. 6, 12, and 13).

Referring to FIGS. 6, 12, and 13, the link 15 is embedded in the wheel cover 10.

The link 15 is embedded in the wheel cover 10 and structurally connects the motor 40 with the wheel cover 10 to serve to constrain positions therebetween.

As an example, one end of the link 15 may be fixed to the inner side of the wheel cover 10. In addition, the other end of the link 15 may be fixed to one side of the motor 40.

For example, the one end of the link 15 may be formed of a rod-shaped straight link portion 151, and the other end of the link 15 may be formed of a circular link portion 152.

The straight link portion 151 may be fixed inside the first connector 113. However, the present disclosure is not limited thereto, and the straight link portion 151 may be fixed inside the second connector 123.

The circular link portion 152 may be connected to a lower end of the straight link portion 151 in a ring shape and fixed to the one side of the motor 40.

For example, the circular link portion 152 may be fixedly fastened to a stator frame 61 for supporting a stator 60 of the motor 40 (see FIG. 8).

In addition, the circular link portion 152 may have a structure in which the inverter cover 80 protruding in a circular cap shape is inserted into an internal hollow of the circular link portion 152 and protrudes outward from the motor 40.

The wheel 20 is a device for receiving a rotating force of the motor 40 and driving the robot to travel. The wheel 20 may have a circular body, and the tire 30 may be coupled to an outer circumferential surface of the wheel 20.

The wheel 20 includes a first wheel body portion 21 and a second wheel body portion 22.

The first wheel body portion 21 may have a disk shape.

The second wheel body portion 22 is a portion protruding in a circular tube shape along an edge of the disk-shaped first wheel body portion 21. The tire 30 may be mounted on an outer circumferential surface of the second wheel body portion 22.

The tire 30 is mounted on the wheel 20. The tire 30 is a member that rotates to roll on the ground according to the rotation of the wheel 20 and moves the robot in a set direction.

Since the tire 30 repeatedly rubs against and is in contact with the ground, the tire 30 may be made of various materials in consideration of durability, slip prevention according to a type of the ground, etc. For example, the tire 30 may be made of a material such as a rubber, but the present disclosure is not necessarily limited thereto.

In order to firmly mount the tire 30 on the wheel 20, a fastening groove 31 may be provided in an inner circumferential surface of the tire 30, and fastening protrusions 23 and 24 may be provided on the outer circumferential surface of the second wheel body portion 22. The fastening protrusions 23 and 24 may be fixedly inserted into the fastening groove 31 (see FIG. 7).

As an example, the fastening protrusions 23 and 24 include the first fastening protrusion 23 and the second fastening protrusion 24 having different shapes.

For example, the first fastening protrusion 23 may be formed in a ring-shaped band shape that surrounds the outer circumferential surface of the second wheel body portion 22 in a circumferential direction.

For example, the second fastening protrusion 24 may protrude in a direction intersecting the first fastening protrusion 23 and may be formed in a straight band shape having a predetermined length in a width direction of the tire. The second fastening protrusion 24 may have a trapezoidal cross section.

In addition, a plurality of second fastening protrusions 24 may be provided, and the plurality of fastening protrusions 24 may be formed along the first fastening protrusion 23 at a predetermined distance.

As described above, since the first fastening protrusion 23 and the second fastening protrusion 24 have a shape that protrudes in directions intersecting each other, the tire 30 of which the fastening groove 31 is fixedly fitted onto the first and second fastening protrusions 23 and 24 may be firmly mounted on the second wheel body portion 22.

The motor housing 50 is a case-shaped component in which the motor 40 is embedded. The motor housing 50 is seated on and coupled to the inner side of the wheel 20 (see FIG. 7).

Referring to FIG. 7, the motor housing 50 may have a cylindrical shape with one open surface and accommodate the motor 40 therein through the one open surface.

For example, the motor housing 50 includes a first motor housing portion 51 and a second motor housing portion 52.

The first motor housing portion 51 is a disk-shaped body seated inside the wheel 20.

The first motor housing portion 51 may be in close contact with an inner side of the first wheel body portion 21.

The second motor housing portion 52 is a circular tube-shaped body that may be in close contact with the inner circumferential surface of the wheel 20.

The second motor housing portion 52 may be in close contact with an inner circumferential surface of the second wheel body portion 22.

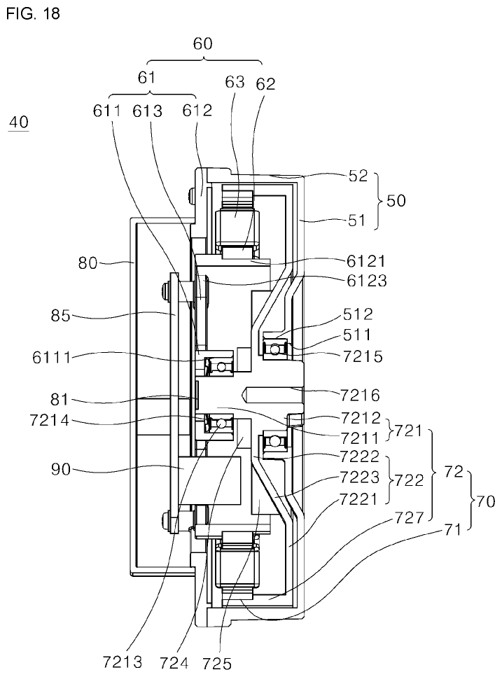

A through hole 511 may be provided at a center of the first motor housing portion 51 (see FIGS. 7 and 18).

The through hole 511 is a circular hole having a predetermined diameter and formed to pass through the first motor housing portion 51 in a thickness direction.

Referring to FIG. 18, the through hole 511 is a portion into which a rear end of a rotational shaft 721 (more specifically, a second rotational shaft portion 7212) of a rotor frame 72 is inserted to pass through the through hole 511.

The rotor frame 72 is fastened to the wheel 20 and rotates together. To this end, the rotational shaft 721 of the rotor frame 72 may pass through the through hole 511 of the first motor housing portion 51, and a through portion of the rotational shaft 721 and the wheel 20 may be integrally fastened using bolts.

The motor 40 is mounted inside the motor housing 50. The motor 40 is a device for providing a rotating force to the wheel 20. In the embodiment of the present disclosure, the motor 40 is an inverter-integrated motor (see FIG. 7).

Referring to FIG. 7, the motor 40 includes a stator 60 and a rotor 70.

The stator 60 is fixedly mounted inside the motor housing 50.

The rotor 70 is disposed outside the stator 60 with an air gap interposed therebetween. The rotor 70 rotates about the stator 60 by supplying power.

The rotor 70 may include fans 724 and 725 (see FIG. 18) for cooling heat generated in the aluminum electrolytic capacitor 90.

When the rotor 70 rotates, the fans 724 and 725 (see FIG. 18) rotate with the rotor 70 to generate air flow. It is possible to prevent an increase in a temperature of the aluminum electrolytic capacitor 90 by the air flow. Here, a positional relationship and cooling operation between the aluminum electrolytic capacitor 90 and the fans 724 and 725 (see FIG. 18) will be described in detail below.

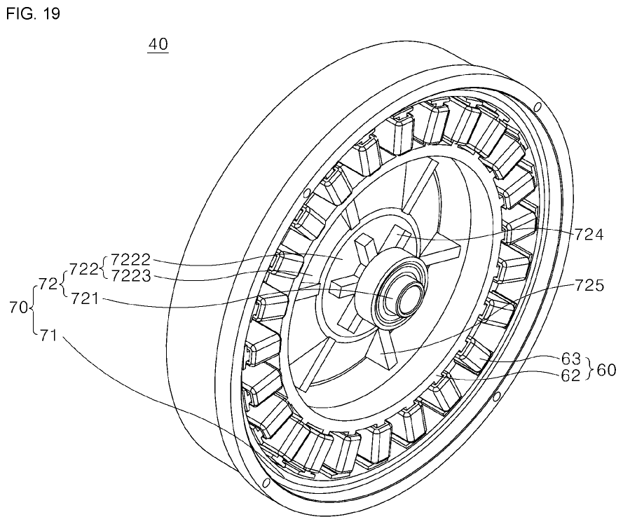

For example, the stator 60 includes a plurality of coils 63 disposed in a circumferential direction, and a stator core 62 on which the plurality of coils 63 are wound and mounted (see FIG. 19).

The rotor 70 includes a magnet 71 and the rotor frame 72 (see FIG. 19).

A plurality of magnets 71 may be disposed in a circumferential direction of the rotor to face the plurality of coils 63 (see FIG. 19).

The rotor frame 72 is a body that fixes the plurality of magnets 71, is connected concentrically to the wheel 20, and rotates inside the motor housing 50.

The fans 724 and 725 may be formed on the rotating rotor frame 72 (see FIG. 19).

The motor 40 is an inverter-integrated motor, and the inverter cover 80 may be connected to the one side of the motor 40.

The inverter cover 80 may have a cylindrical cap shape that covers the open portion of the motor housing 50. The inverter cover 80 may be connected to the motor in an integrated structure (see FIG. 7).

The aluminum electrolytic capacitor 90 may be used for an inverter DC link (see FIG. 7).

The aluminum electrolytic capacitor 90 may be disposed to protrude from the inner side of the inverter cover 80 in a direction opposite to the inverter cover 80 (i.e., a direction toward the inside of the motor 40) (see FIG. 18).

That is, the aluminum electrolytic capacitor 90 may be disposed in a structure in which at least a part is accommodated in an empty space inside the motor 40 (see FIG. 18).

The aluminum electrolytic capacitor 90 has a predetermined height.

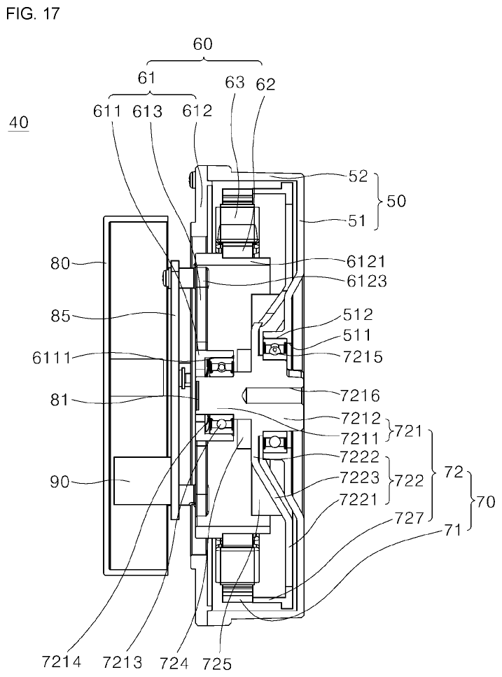

When the aluminum electrolytic capacitor 90 is disposed to protrude in a direction toward the inverter cover 80 (see FIG. 17), a height of the inverter cover 80, which is a size, increases, and a weight thereof increases. Therefore, there is a problem against the miniaturization and light-weight of the motor.

According to the embodiment of the present disclosure, the aluminum electrolytic capacitor 90 protrudes in the direction opposite to the inverter cover 80, that is, in the direction in which the aluminum electrolytic capacitor 90 faces the inside of the motor 40 (FIGS. 8 and 18).

Therefore, at least a part of the aluminum electrolytic capacitor 90 in a height direction may be accommodated in the empty space inside the motor 40 (i.e., a remaining space inside the motor).

As a result, according to the embodiment of the present disclosure, it is possible to prevent an increase in the height (i.e., the size) of the inverter-integrated motor 40 while using the aluminum electrolytic capacitor 90 and achieve the miniaturization and light-weight of the motor.

The PCB 85 is positioned inside the inverter cover 80. The PCB 85 is disposed to face the motor 40. Although not separately illustrated, a plurality of inverter circuit elements may be disposed on the PCB 85. In addition, a component such as an encoder sensor for detecting the rotation of the motor 40 may be further disposed on the PCB 85.

The aluminum electrolytic capacitor 90 is disposed on the PCB 85. The aluminum electrolytic capacitor 90 may be disposed on one facing the inside of the motor 40 between both surfaces of the PCB 85. Therefore, the aluminum electrolytic capacitor 90 may have a cantilever structure in which one end of the aluminum electrolytic capacitor 90 is connected to one surface of the PCB 85 and the other end protrudes to a predetermined height toward the empty space inside the motor 40.

In addition, the aluminum electrolytic capacitor 90 may be disposed at a position spaced a predetermined distance from a center of the motor 40 (more specifically, a center of the motor 40 at which the rotational shaft 721 (see FIG. 18) is positioned) in a radial direction.

Therefore, the aluminum electrolytic capacitor 90 having the predetermined height may be stably accommodated in the empty space inside the motor 40 without interference with nearby structures during rotation of the motor 40.

As described above, the robot wheel driving apparatus 1 according to the embodiment of the present disclosure may use the aluminum electrolytic capacitor instead of the MLCC for an DC link of the inverter-integrated motor.

The conventional MLCC has good high-frequency characteristics, but has a disadvantage of having high risk of cracking of the MLCC caused by thermal deformation of the PCB.

In addition, the MLCC is expensive, and since each capacitance of the MLCC is small, the plurality of MLCCs need to be disposed in parallel on the PCB. Therefore, when the plurality of MLCCs are disposed on the PCB, there is a disadvantage in that an arrangement area in the PCB is insufficient and an arrangement space is restricted.

According to the embodiment of the present disclosure, the aluminum electrolytic capacitor 90 that is relatively inexpensive and applicable as a single component may be used to solve the disadvantages upon using the MLCC.

In addition, a protruding direction and arrangement position of the aluminum electrolytic capacitor 90 are formed to face the inside of the motor in order to prevent the size and weight of the motor from being increased due to the height of the aluminum electrolytic capacitor 90.

In addition, the dedicated fans 724 and 725 (see FIG. 18) for cooling the aluminum electrolytic capacitor 90 are formed on the rotor 70 in order to solve a phenomenon in which the aluminum electrolytic capacitor 90 is heated in a high frequency band.

Therefore, it is possible to achieve the miniaturization and light-weight of the inverter-integrated motor 40 applied to the robot wheel driving apparatus 1 and prevent an increase in the temperature of the aluminum electrolytic capacitor 90.

[Detailed Configuration of Inverter-Integrated Motor]

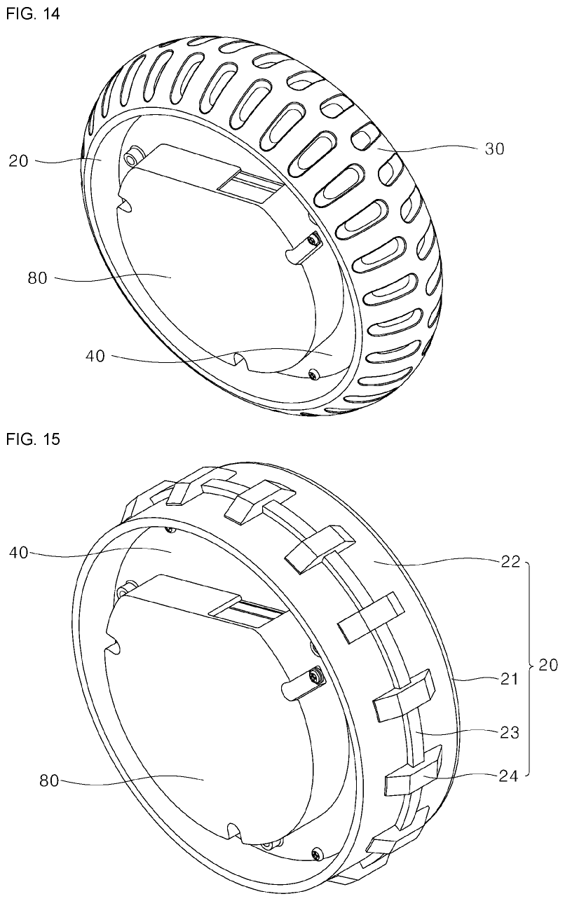

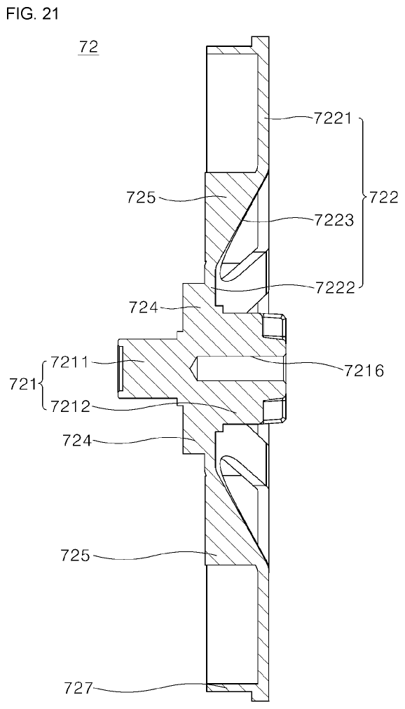

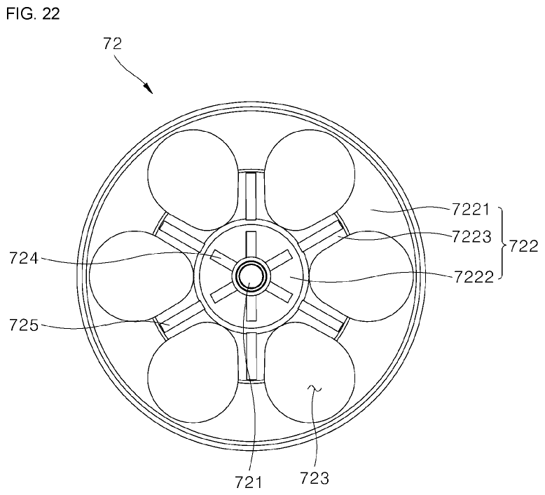

Hereinafter, a detailed configuration, a coupling relationship and operational effects of the inverter-integrated motor applicable to the robot wheel driving apparatus will be described in detail with reference to FIGS. 14 to 26.

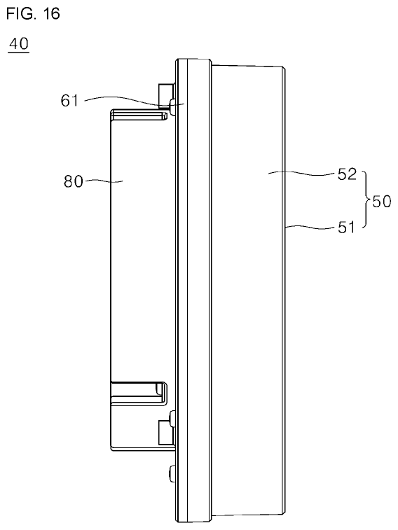

FIG. 14 is a view illustrating a detailed configuration of a tire, a wheel, and a motor in a structure in which the wheel cover is removed from the robot wheel driving apparatus. FIG. 15 is a view illustrating a detailed configuration of the wheel and the motor in a structure in which the tire is removed from FIG. 14. FIG. 16 is a view illustrating a detailed configuration of the motor in a structure in which the wheel is removed from FIG. 15.

Referring to FIG. 14, the tire 30 is mounted on the wheel 20. The tire 30 rolls on the ground according to the rotation of the wheel 20 and moves the robot in the set direction. Since the tire 30 repeatedly rubs against and is in contact with the ground, the tire 30 may be made of an appropriate material in consideration of durability, slip prevention with the ground, etc. For example, the tire 30 may be made of a rubber.

Referring to FIG. 15, the wheel 20 is configured to rotate by receiving a rotating force of the motor 40 and has a circular body.

The wheel 20 includes the first wheel body portion 21 and the second wheel body portion 22. For example, the first wheel body portion 21 has a disk shape, and the second wheel body portion 22 protrudes along the edge of the first wheel body portion 21 in the circular tube shape. The tire 30 (see FIG. 14) is mounted on the outer circumferential surface of the second wheel body portion 22.

In order for the tire 30 (see FIG. 14) to be mounted on the wheel 20, the fastening groove 31 (see FIG. 7) is provided on the inner circumferential surface of the tire 30. The fastening protrusions 23 and 24 are provided on the outer circumferential surface of the second wheel body portion 22 in correspondence to the fastening groove 31 (see FIG. 7).

Referring to FIG. 15, the fastening protrusions 23 and 24 include the first fastening protrusion 23 and the second fastening protrusion 24. The first fastening protrusion 23 may be formed in a ring-shaped band shape that surrounds the outer circumferential surface of the second wheel body portion 22 in the circumferential direction. The second fastening protrusion 24 may protrude in the direction intersecting the first fastening protrusion 23 and may be formed in the straight band shape having the predetermined length in the width direction of the tire. In addition, the plurality of second fastening protrusions 24 may be provided, and the plurality of fastening protrusions 24 may be formed along the first fastening protrusion 23 at the predetermined distance.

Referring to FIG. 16, the motor housing 50 in which the motor 40 is embedded is coupled to the inner side of the wheel 20 (see FIG. 14) and has the cylindrical shape with one open surface. The motor 40 may be embedded through the one open surface of the motor housing 50.

Referring to FIG. 16, the motor housing 50 includes the first motor housing portion 51 and the second motor housing portion 52. The first motor housing portion 51 is a disk-shaped body seated inside the wheel 20 and may be in close contact with the inner side of the first wheel body portion 21 (see FIG. 14). In addition, the second motor housing portion 52 is a circular tube-shaped body in close contact with the inner circumferential surface of the wheel 20 and may be in close contact with the inner circumferential surface of the second wheel body portion 22 (see FIG. 14).

Referring to FIG. 16, the stator frame 61 is coupled to the one open surface of the motor housing 50, and the inverter cover 80 having the cylindrical cap shape is connected to the motor 40 with the stator frame 61 interposed therebetween.

FIG. 17 is a cross-sectional view illustrating an internal structure of a motor when an aluminum electrolytic capacitor is disposed to protrude toward an inverter cover, and FIG. 18 is a cross-sectional view illustrating an internal structure of a motor when the aluminum electrolytic capacitor is disposed to protrude in a direction opposite to the inverter cover according to one embodiment of the present disclosure.

As illustrated, the through hole 511 having the predetermined diameter is provided at the center of the first motor housing portion 51.

The through hole 511 is a portion into which the rear end of the rotational shaft 721 (more specifically, the second rotational shaft portion 7212) of the rotor frame 72 is inserted to pass through the through hole 511.

In the robot wheel driving apparatus 1 according to the embodiment of the present disclosure, the rotor frame 72 is concentrically fastened to the wheel 20 and configured to rotate together.

To this end, the rotational shaft 721 of the rotor frame 72 has a structure in which a rear end is exposed to the outside by passing through the through hole 511 of the first motor housing portion 51. In addition, a fastening groove 7216 is provided at the center of the rear end of the rotational shaft 721 exposed to the outside. The center of the wheel 20 may be bolt-fastened to the rotational shaft 721 through the fastening groove 7216. Therefore, the rotor frame 72 and the wheel 20 may be concentrically fastened to rotate together.

The motor 40 is mounted inside the motor housing 50.

The motor 40 includes the stator 60 and the rotor 70.

The stator 60 is fixedly mounted inside the motor housing 50. For example, the stator 60 includes the plurality of coils 63 disposed in the circumferential direction, and the stator core 62 on which the plurality of coils 63 are wound and mounted (see FIG. 19).

The rotor 70 is disposed outside the stator 60 with the air gap interposed therebetween. The rotor 70 rotates about the stator 60 by supplying power. For example, the rotor 70 includes the magnet 71 and the rotor frame 72. The plurality of magnets 71 may be disposed in the circumferential direction to face the plurality of coils 63. In addition, the rotor frame 72 fixes the plurality of magnets 71, is connected concentrically to the wheel 20, and rotates inside the motor housing 50 (see FIG. 19).

In addition, the motor 40 further includes the fans 724 and 725.

The fans 724 and 725 may be formed on the rotor 70. The fans 724 and 725 cool heat generated in the aluminum electrolytic capacitor 90.

Specifically, the fans 724 and 725 rotate with the rotor 70 when the rotor 70 rotates.

The rotation of the fans 724 and 725 may generate air flow inside the motor 40, and the heat generated in the aluminum electrolytic capacitor 90 may be quickly cooled by the air flow. Therefore, it is possible to prevent the increase in the temperature of the aluminum electrolytic capacitor 90.

For example, the fans 724 and 725 may be formed inside the rotor frame 72. Therefore, air flow may be generated in a radial direction and a vertical direction of the motor 40 inside the rotor frame 72.

As an example, referring to FIG. 18, the fans 724 and 725 include the first fan 724 and the second fan 725.

For example, the first fan 724 may be positioned relatively inward of the rotor 70 in the radial direction compared to the second fan 725.

The first fan 724 rotates with the rotor 70 to generate air flow toward the aluminum electrolytic capacitor 90.

Therefore, the first fan 724 may rapidly cool the aluminum electrolytic capacitor 90 by flowing air toward the side surface of the aluminum electrolytic capacitor 90 protruding to the predetermined height.

For example, the second fan 725 is disposed to be spaced a predetermined distance from the first fan 724. The second fan 725 may be positioned relatively outward of the rotor 70 in the radial direction compared to the first fan 724.

The second fan 725 rotates with the rotor 70 to generate air flow toward the aluminum electrolytic capacitor 90.

At this time, the second fan 725 enables air to flow in a direction different from that of the first fan 724.

For example, since the second fan 725 is positioned close to a front end of the aluminum electrolytic capacitor 90 protruding to the predetermined height, the aluminum electrolytic capacitor 90 may be quickly cooled by flowing air at this position.

As described above, the first fan 724 is disposed close to one side of the aluminum electrolytic capacitor 90, and the second fan 725 is disposed to face the front end of the aluminum electrolytic capacitor 90.

As described above, the first fan 724 and the second fan 725 disposed at different positions may generate air flow toward the aluminum electrolytic capacitor 90 in different directions, thereby improving the effect of preventing the increase in the temperature of the aluminum electrolytic capacitor 90.

A part of a protrusion portion of the aluminum electrolytic capacitor 90 may be accommodated in the empty space inside the motor provided between the first fan 724 and the second fan 725.

Compared to the case in which the aluminum electrolytic capacitor 90 protrudes toward the inverter cover 80 (see FIG. 17), the height of the inverter cover 80 is reduced in the case in which the aluminum electrolytic capacitor 90 protrudes in the direction opposite to the inverter cover 80 (see FIG. 18).

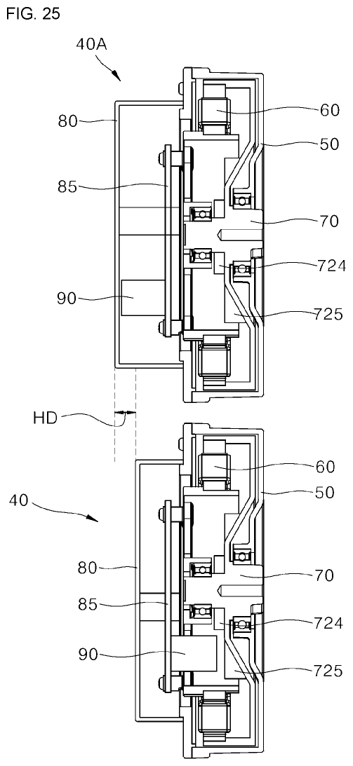

Referring to FIG. 25, a height difference HD between an inverter motor 40A in which the aluminum electrolytic capacitor 90 protrudes toward the inverter cover 80 and the inverter motor 40 in which the aluminum electrolytic capacitor 90 protrudes in the direction opposite to the inverter cover 80 is illustrated.

A size of the inverter motor 40 is reduced by the height difference HD, and a weight thereof is reduced.

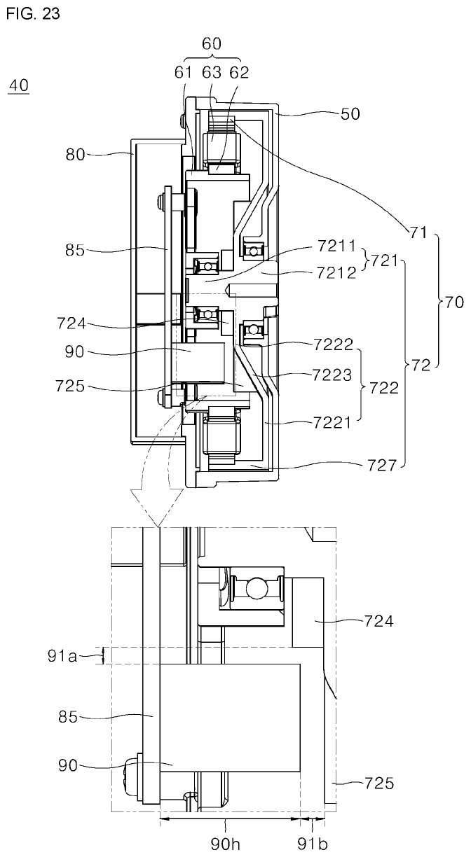

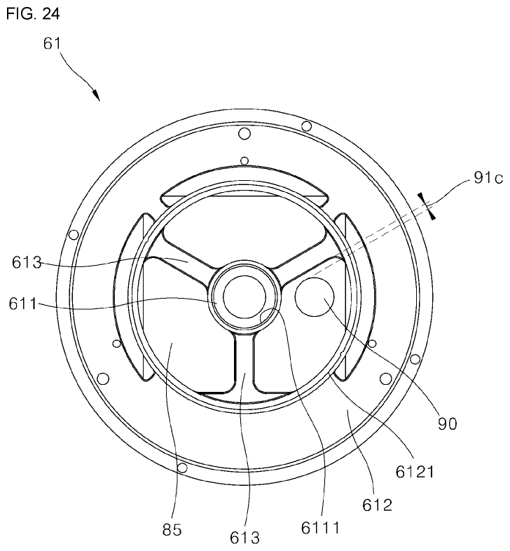

Meanwhile, the aluminum electrolytic capacitor 90 protrudes to a predetermined height 90h to the empty space inside the motor (see FIG. 23).

In this case, a first insulation distance is formed between the aluminum electrolytic capacitor 90 and the first fan 724. To this end, a first gap portion 91a (see FIG. 23) is formed between the aluminum electrolytic capacitor 90 and the first fan 724.

In addition, a second insulation distance is formed between the aluminum electrolytic capacitor 90 and the second fan 725. To this end, a second gap portion 91b (see FIG. 23) is formed between the aluminum electrolytic capacitor 90 and the second fan 725.

[Detailed Structure of Stator, Rotor, and Fan]

Hereinafter, a detailed configuration of the stator 60, the rotor 70, and the fans 724 and 725 will be described in detail with reference to FIGS. 18 to 24.

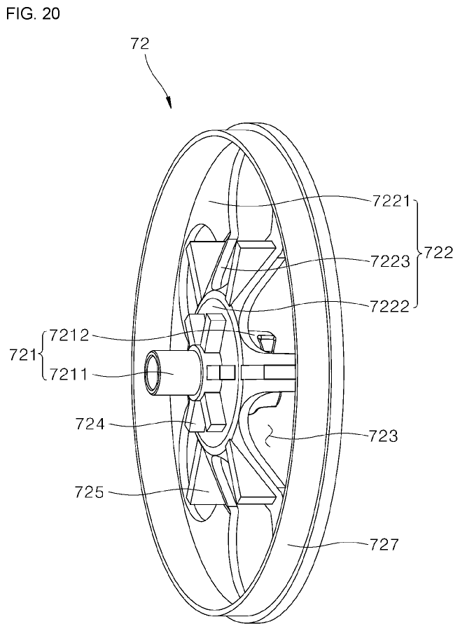

FIG. 18 is a cross-sectional view illustrating an internal structure of a motor of the robot wheel driving apparatus according to one embodiment of the present disclosure, and FIG. 19 is a perspective view illustrating a structure of a stator and a rotor constituting the motor. FIGS. 20, 21, and 22 are a perspective view, a cross-sectional view, and a plan view of the rotor frame. FIGS. 23 and 24 are views illustrating a structure in which a first gap portion, a second gap portion, and a third gap portion are formed.

Referring to FIGS. 18 and 19, the motor 40 includes the stator 60, the rotor 70, and the fans 724 and 725.

The stator 60 includes the plurality of coils 63 disposed in the circumferential direction and the stator core 62 on which the plurality of coils 63 are wound and mounted.

The rotor 70 is disposed outside the stator 60 with an air gap interposed therebetween and rotates about the stator 60 by an electromagnetic force generated by supplying power. The rotor 70 includes the magnet 71 and the rotor frame 72.

The plurality of magnets 71 may be disposed in the circumferential direction to face the plurality of coils 63.

The rotor frame 72 fixes the plurality of magnets 71, is connected concentrically to the wheel 20, and rotates inside the motor housing 50.

The fans 724 and 725 may be formed inside the rotor frame 72. The fans 724 and 725 rotate with the rotor frame 72 and generate air flow in different directions.

The aluminum electrolytic capacitor 90 may be cooled using the air flow generated by the rotation of the fans 724 and 725, thereby preventing the increase in the temperature.

As a specific example, the rotor frame 72 includes the rotational shaft 721, a first rotor frame portion 722, and a second rotor frame portion 727.

The rotational shaft 721 is a shaft positioned at a rotation center of the rotor frame 72.

For example, the rotational shaft 721 may be formed in a rounded rod shape that extends in a central direction of the motor 40.

As an example, the rotational shaft 721 includes a first rotational shaft portion 7211 and the second rotational shaft portion 7212.

The first rotational shaft portion 7211 is a portion positioned at a front end of the rotational shaft 721 and supported by a first bearing 7213.

The second rotational shaft portion 7212 is a portion positioned ata rear end of the rotational shaft 721 and has a shape having a greater diameter than the first rotational shaft portion 7211.

The second rotational shaft portion 7212 is integrally connected to a rear end of the first rotational shaft portion 7211 and supported by a second bearing 7215 spaced a predetermined distance from the first bearing 7213 in a front-rear direction.

A wave washer 7214 may be further provided at a front end of the first bearing 7213.

The first rotor frame portion 722 is a disk-shaped body connected to the rotational shaft 721.

The second rotor frame portion 727 is a circular tube-shaped body protruding to a predetermined length from an edge of the first rotor frame portion 722 and may have the plurality of magnets 71 fixedly disposed to surround the second rotor frame portion in the circumferential direction.

For example, the fans 724 and 725 may be formed on the first rotor frame portion 722.

More specifically, the first rotor frame portion 722 includes an outer frame 7221, an inner frame 7222, and an inclined frame 7223 (see FIGS. 20, 21, and 22).

The outer frame 7221 is a disk-shaped frame formed at a position far from the center of the motor 40 in the radial direction.

The inner frame 7222 is a disk-shaped frame formed at a position close to the center of the motor 40 in the radial direction and connected to the outer frame 7221 with a step therebetween. That is, the inner frame 7222 is disposed to have a height difference from the outer frame 7221.

The inclined frame 7223 connects the outer frame 7221 with the inner frame 7222.

The fans 724 and 725 include the first fan 724 and the second fan 725.

The first fan 724 protrudes to a predetermined height from the inner frame 7222 toward the rotational shaft 721 and cools the aluminum electrolytic capacitor 90.

The second fan 725 protrudes to a predetermined height from the inclined frame 7223 in a right-angled triangle shape and cools the aluminum electrolytic capacitor 90 by generating air flow at a different position from the first fan 724.

The first fan 724 protrudes from the inner frame 7222 in a rectangular wing shape. The first fan 724 may be radially disposed to surround the rotational shaft 721 that is a center. As an example, six first fans 724 may be disposed at 60 degree intervals about the rotational shaft 721 (see FIG. 22).

The first fan 724 rotates with the rotor frame 72 to generate air flow around the aluminum electrolytic capacitor 90, thereby preventing the increase in the temperature of the heated Aluminum electrolytic capacitor 90.

The second fan 725 protrudes from the inclined frame 7223 in a right-angled triangle wing shape.

The second fan 725 may be radially disposed based on the rotational shaft 721 parallel to the first fan 724. As an example, six second fans 725 may be disposed at 60 degree intervals based on the rotational shaft 721 (see FIG. 22).

The second fan 725 rotates with the rotor frame 72 to generate air flow around the aluminum electrolytic capacitor 90 at a different position from the first fan 724, thereby preventing the increase in the temperature of the heating aluminum electrolytic capacitor 90.

As described above, the first fan 724 and the second fan 725 are formed at different positions of the first rotor frame portion 722 and configured to rotate simultaneously when the rotor frame 72 rotates. Therefore, it is possible to generate air flow in various directions around the aluminum electrolytic capacitor 90, thereby preventing the increase in the temperature of the aluminum electrolytic capacitor 90.

For example, the first fan 724 is formed to rotate at a position close to the side surface of the aluminum electrolytic capacitor 90. In addition, the second fan 725 is formed to rotate close to the protruding front end of the aluminum electrolytic capacitor 90. A complicated air flow generated by the rotation of the plurality of fans 724 and 725 formed at different positions may more effectively cool the aluminum electrolytic capacitor 90.

The first fan 724 may protrude to a first set height in an axial direction, that is, in a direction in which the rotational shaft 721 is formed. The second fan 725 may protrude to a second set height in the axial direction, that is, in the direction in which the rotational shaft 721 is formed.

For example, the second fan 725 may protrude higher than the first fan 724. For example, the first set height of the first fan 724 may be 3 mm, and the second set height of the second fan 725 may be 7 mm.

In addition, the first fan 724 may have a rectangular wing shape having a first set length in the radial direction of the motor 40. The second fan 725 may have a right-angled triangle wing shape having a second set length in the radial direction of the motor 40.

For example, the second fan 725 may be formed to be longer than the first fan 724. For example, the first set length of the first fan 724 may be 7 mm, and the second set length of the second fan 725 may be 12 mm.

Since the air flow generated by the rotation of the first fan 724 and the second fan 725 is directed from the inside to the outside and from the top to the bottom with respect to the rotational shaft 721, it is advantageous in the heat exchange of the aluminum electrolytic capacitor 90, and it is possible to prevent the increase in the temperature of the aluminum electrolytic capacitor 90.

The aluminum electrolytic capacitor 90 is characterized by an increase in heat generation and an increase in temperature due to an increase in resistance in a high frequency band.

When the aluminum electrolytic capacitor 90 protrudes toward the inverter cover 80 upon disposed on the PCB 85 (see FIG. 17), air is stagnant in the space between the inverter cover 80 and the PCB 85. Therefore, there is no way to prevent the increase in temperature caused by heating of the aluminum electrolytic capacitor 90.

Conventionally, some improvement methods for heat dissipation, such as applying a heat-radiation fin structure to the outside of the inverter cover 80, have been suggested, but since air is stagnant inside the inverter cover 80, there is no way to prevent the increase in the temperature of the aluminum electrolytic capacitor 90.

According to the embodiment of the present disclosure, the aluminum electrolytic capacitor 90 has a structure protruding toward the empty space inside the motor 40. In addition, the first fan 724 and the second fan 725 rotating with the rotor frame 72 may be used to generate complicated air flow. Therefore, it is possible to solve the problem of the increase in the temperature of the aluminum electrolytic capacitor 90 caused by heating.

The first fan 724 is formed on the inner frame 7222 and positioned inside the motor 40 in the radial direction. The second fan 725 is formed on the inclined frame 7223 and positioned at the outer side of the motor 40 in the radial direction. In addition, the shapes of the first fan 724 and the second fan 725 are not necessarily limited to the illustrated shapes and may have various other modified examples.

The aluminum electrolytic capacitor 90 may be accommodated in the empty space (i.e., the spare space) inside the motor 40 provided between the first fan 724 and the second fan 725.

Referring to FIG. 23, the aluminum electrolytic capacitor 90 with the predetermined height 90h protrudes toward the empty space inside the motor.

For example, the protrusion of the aluminum electrolytic capacitor 90 may be accommodated in a remaining empty space between the rotational shaft 721 and a region in which the plurality of coils 63 are wound.

In this case, the first gap portion 91a may be formed between the aluminum electrolytic capacitor 90 and the side surface of the first fan 724.

In addition, the second gap portion 91b may be formed between the protruding front end of the aluminum electrolytic capacitor 90 and the second fan 725.

For example, each of the first gap portion 91a and the second gap portion 91b may have a distance of at least 1.5 mm. Preferably, each of the first gap portion 91a and the second gap portion 91b may have a distance of 1.6 mm.

The first gap portion 91a is a separation space between the aluminum electrolytic capacitor 90 and the first fan 724, and the first gap portion 91a may be formed to secure a distance of at least 1.5 mm.

The first insulation distance may be sufficiently secured between the aluminum electrolytic capacitor 90 and the first fan 724 by the first gap portion 91a. As a result, it is possible to secure the insulation of the aluminum electrolytic capacitor 90, thereby preventing failure and lifetime shortening, and improve the stability and reliability in use of the robot wheel driving apparatus 1.

The second gap portion 91b is a separation space between the aluminum electrolytic capacitor 90 and the second fan 725, and the second gap portion 91b may be formed to secure a distance of at least 1.5 mm.

The second insulation distance may be sufficiently secured between the aluminum electrolytic capacitor 90 and the second fan 725 by the second gap portion 91b. As a result, it is possible to secure the insulation of the aluminum electrolytic capacitor 90, thereby preventing failure and lifetime shortening, and improve the stability and reliability in use of the robot wheel driving apparatus 1.

A sensor magnet 81 may be coupled to the rotational shaft 721 (see FIG. 18).

The sensor magnet 81 may be coupled to a front end of the first rotational shaft portion 7211.

The sensor magnet 81 may be positioned to face an encoder sensor (not illustrated) disposed on the PCB 85 at a set distance. Therefore, the encoder sensor (not illustrated) may detect the rotation of the motor 40 by detecting the sensor magnet 81 coupled to the front end of the first rotational shaft portion 7211.

Meanwhile, a female screw-shaped fastening groove 7216 for bolt-fastening with the wheel 20 is provided at the rear end of the second rotational shaft portion 7212 positioned at the rear end of the rotational shaft 721.

The fastening groove 7216 is positioned at the rotation center of the rotational shaft 721, and a bolt passing through the center of the wheel 20 is fastened thereto.

Therefore, the wheel 20 and the rotor frame 72 may be concentrically fastened. As a result, since the rotor frame 72 may rotate with the wheel 20, the rotation of the wheel required for the robot to travel may be possible.

Meanwhile, the first rotor frame portion 722 may further include a plurality of holes 723 passing therethrough in a thickness direction except for the positions at which the fans 724 and 725 are formed (see FIG. 22).

The plurality of holes 723 may be formed in a region in which no fans 724 and 725 are formed in the first rotor frame portion 722 having a disk-shaped body.

Referring to FIG. 22, the plurality of holes 723 may be formed in the inclined frame 7223 and the outer frame 7221 in which no second fan 725 is formed.

As an example, the plurality of holes 723 may be six, and the holes may be radially formed to be spaced apart from each other with respect to the center of the motor 40.

The fans 724 and 725 are formed on the first rotor frame portion 722 to rotate with the first rotor frame portion 722 and generate air flow, and cool the aluminum electrolytic capacitor 90. The plurality of holes 723 may be formed in the region in which no fans 724 and 725 are formed in the first rotor frame portion 722 to allow air to flow into the motor 40, thereby improving the cooling effect.

In addition, the plurality of holes may reduce the weight of the motor 40 by reducing the use of unnecessary materials in the first rotor frame portion 722.

Meanwhile, the motor 40 further includes the disk-shaped stator frame 61 coupled to the one open surface of the motor housing 50 to support the stator 60.

One surface of the stator frame 61 may be coupled to the motor housing 50 to cover the open portion of the motor housing 50.

The inverter cover may be coupled to the other surface of the stator frame 61.

The PCB 85 may be fastened to the stator frame 61 and positioned inside the inverter cover 80.

For example, the stator frame 61 includes a first stator frame portion 611, a second stator frame portion 612, and a third stator frame portion 613 (see FIG. 24).

Referring to FIG. 24, the first stator frame portion 611 may have a circularly protruding shape to face the center of the motor 40. The second stator frame portion 612 may have a shape that circularly protrudes to a predetermined distance in the radial direction from the first stator frame portion 611. The third stator frame portion 613 is a spoke-shaped support that radially connects the first stator frame portion 611 to the second stator frame portion 612. In this case, the PCB 85 may be fastened to the second stator frame portion 612.

Referring to FIG. 24, it can be confirmed that a positional relationship between a planar shape of the aluminum electrolytic capacitor 90 disposed to protrude to a predetermined height from one surface of the PCB 85 and the third stator frame portion 613.

Specifically, a third gap portion 91c may be formed between the aluminum electrolytic capacitor 90 and the third stator frame portion 613.

It is preferable that the third gap portion 91c has a distance of at least 1.5 mm.

The third gap portion 91c is formed to secure an insulation distance required between the aluminum electrolytic capacitor 90 and the third stator frame portion 613. The third gap portion 91c can secure the insulation of the aluminum electrolytic capacitor 90, thereby preventing the failure and lifetime shortening of the component. For example, the third gap portion 91c may have a distance of 1.6 mm identical to the first and second gap portions 91a and 91b.

A cylindrical groove 6111 is formed at the center of the first stator frame portion 611. The cylindrical groove 6111 is a region where the front end of the first rotational shaft portion 7211 is inserted and supported.

In addition, the first bearing 7213 is inserted between the cylindrical groove 6111 and the front end of the first rotational shaft portion 7211 to support the first rotational shaft portion 7211 (see FIG. 18).

The second rotational shaft portion 7212 is supported by the second bearing 7215. The motor housing 50 includes the disk-shaped first motor housing portion 51 and the circular tube-shaped second motor housing portion 52, and the through hole 511 is formed at the center of the first motor housing portion 51. In addition, a cylindrical support groove 512 is provided around the through hole 511. The second bearing 7215 is inserted into the support groove 512 of the first motor housing portion 51 to support the second rotational shaft portion 7212 (see FIG. 18).

Meanwhile, the second stator frame portion 612 includes a circular protrusion 6121 protruding toward the inside of the motor 40. The circular protrusion 6121 protrudes toward the inside of the motor, and the protruding outer circumferential surface of the circular protrusion 6121 and the inner circumferential surface of the stator core 62 may be firmly supported in close contact with each other. As a result, the stator core 62 may be supported by the second stator frame portion 612 (see FIG. 18).

In addition, the second stator frame portion 612 includes a plurality of PCB fastening portions 6123. The plurality of PCB fastening portions 6123 are circular boss-shaped portions that couple the PCB 85 with the second stator frame portion 612 by a bolt-fastening method.

FIG. 25 illustrates a comparison between a comparative example 40A in which the aluminum electrolytic capacitor 90 protrudes to the inside of the inverter cover 80 and the motor 40 according to the embodiment of the present disclosure in which the aluminum electrolytic capacitor 90 protrudes in the direction opposite to the inverter cover 80.

Referring to FIG. 25, it can be confirmed that the height of the motor 40 according to the embodiment of the present disclosure is reduced by the predetermined height difference HD compared to the comparative example 40A in which the aluminum electrolytic capacitor 90 protrudes toward the inside of the inverter cover 80. It is possible to reduce the size of the inverter-integrated motor 40 by the height difference HD and it is advantageous in miniaturization and light-weight of the motor.

As described above, the robot wheel driving apparatus 1 according to the embodiment of the present disclosure uses the aluminum electrolytic capacitor 90 that is inexpensive and applicable as a single component in order to solve the disadvantages of the use of the MLCC.

However, in order to prevent the entire size and weight of the motor from being increased due to the increase in the height of the inverter cover 80 caused by the height of the aluminum electrolytic capacitor 90, the aluminum electrolytic capacitor 90 protrudes in the direction opposite to the inverter cover 80.

In addition, in order to prevent the increase in the temperature of the aluminum electrolytic capacitor 90 protruding to the empty space inside the motor caused by heating, the fans 724 and 725 used for cooling the aluminum electrolytic capacitor 90 are formed on the rotor 70.

Therefore, it is possible to achieve the miniaturization and light-weight of the inverter-integrated motor 40 applied to the robot wheel driving apparatus 1 and prevent the increase in the temperature of the aluminum electrolytic capacitor 90.

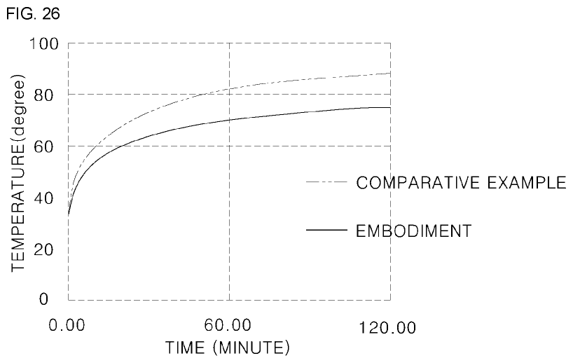

FIG. 26 is a temperature saturation comparison graph of an embodiment in which a fan is applied to a rotor of the robot wheel driving apparatus and a comparative example in which no fan is applied thereto.

Referring to FIG. 26, when the aluminum electrolytic capacitor was applied to the inverter-integrated motor of the robot wheel driving apparatus, in the embodiment of the present disclosure in which the fan was applied to the rotor in order to prevent the increase in temperature in the high frequency band, the saturation temperature was 74° C.

In the comparative example in which the aluminum electrolytic capacitor was applied and no fan was applied, the saturation temperature was 86° C.

Based on the results of FIG. 26, it can be confirmed that the embodiment of the present disclosure to which the fan was applied has the effect of reducing the temperature saturation of 12 degrees compared to the comparative example to which no fan was applied.

According to embodiments of the present disclosure, it is possible to prevent a size and weight of the entire motor from being increased due to an increase in a height of an aluminum electrolytic capacitor upon using the aluminum electrolytic capacitor for a DC link in an inverter-integrated motor. Therefore, it is possible to achieve the miniaturization and light-weight of the robot wheel driving apparatus.

In addition, according to the embodiments of the present disclosure, the aluminum electrolytic capacitor is disposed in a direction opposite to an inverter cover (i.e., a direction toward an inside of the motor) in consideration of the characteristics that the aluminum electrolytic capacitor is heated by an increase in a resistance component in a high frequency band. In addition, a fan is applied to a rotor (as a specific example, a rotor frame), and thus air flow can be forcibly generated for cooling the aluminum electrolytic capacitor. Therefore, it is possible to prevent an increase in a temperature of the aluminum electrolytic capacitor.

In addition, according to the embodiments of the present disclosure, it is possible to sufficiently secure an insulation distance between the aluminum electrolytic capacitor and a motor component. Therefore, it is possible to increase durability of the aluminum electrolytic capacitor and improve stability and reliability in use of the robot wheel driving apparatus.

Specific effects together with the above-described effects are described with a description of the following detailed matters for carrying out the disclosure.

Although the present disclosure has been described above with reference to exemplary drawings, the present disclosure is not limited by the embodiments and drawings disclosed in the specification, and it is apparent that various modifications can be made by those skilled in the art within the scope of the technical spirit of the present disclosure. In addition, even when the operational effects according to the configuration of the present disclosure have not been explicitly described in the description of the embodiments of the present disclosure, it goes without saying that the effects predictable by the corresponding configuration should be recognized.

What is claimed is:

1. A robot wheel driving apparatus comprising:
a wheel configured to rotate and move a robot;
a motor housing provided inside the wheel and having a cylindrical shape, the motor housing defining an open surface;
a motor inserted into the motor housing and configured to provide a rotational force to the wheel;
an inverter cover connected to the motor and covering the open surface of the motor housing; and
an aluminum electrolytic capacitor protruding from an inside of the inverter cover in a direction opposite to the inverter cover, at least a part of the aluminum electrolytic capacitor being accommodated in the motor.

2. The robot wheel driving apparatus of claim 1, further comprising a printed circuit board (PCB) provided inside the inverter cover and facing the motor,
wherein the aluminum electrolytic capacitor is disposed on a first surface of the PCB, the first surface facing the motor and disposed between lateral surfaces of the PCB.

3. The robot wheel driving apparatus of claim 1, wherein the aluminum electrolytic capacitor protrudes toward an empty space within the motor and disposed at a predetermined distance from a center of the motor in a radial direction.

4. The robot wheel driving apparatus of claim 1, wherein the motor includes:
a stator disposed in the motor housing, and
a rotor disposed at an outside of the stator, separated from the stator by an air gap, and configured to rotate with respect to the stator, and
wherein the rotor comprises a fan configured to reduce a temperature of the aluminum electrolytic capacitor.

5. The robot wheel driving apparatus of claim 1, wherein the motor includes:
a stator disposed in the motor housing, and
a rotor disposed at an outside of the stator, separated from the stator by an air gap, and configured to rotate with respect to the stator,
wherein the rotor comprises a fan configured to reduce a temperature of the aluminum electrolytic capacitor, and
wherein the fan includes:
a first fan disposed in the rotor in a radial direction and configured to rotate with the rotor to reduce a temperature of the aluminum electrolytic capacitor, and
a second fan disposed at an outside of the rotor in the radial direction at a predetermined distance from the first fan and configured to rotate with the rotor to reduce the temperature of the aluminum electrolytic capacitor.

6. The robot wheel driving apparatus of claim 5, wherein at least a part of the aluminum electrolytic capacitor is accommodated in an empty space inside the motor and provided between the first fan and the second fan,
wherein the aluminum electrolytic capacitor and the first fan are separated by a first insulation distance, and
wherein the aluminum electrolytic capacitor and the second fan are separated by a second insulation distance.

7. The robot wheel driving apparatus of claim 1, wherein the motor includes:
a stator disposed in the motor housing,
a rotor disposed at an outside of the stator, separated from the stator by an air gap, and configured to rotate with respect to the stator, and
a fan configured to reduce a temperature of the aluminum electrolytic capacitor,
wherein the stator includes:
a plurality of coils disposed in a circumferential direction of the stator, and
a stator core on which the plurality of coils are wound and mounted, wherein the rotor includes:
a plurality of magnets facing the plurality of coils in a circumferential direction of the rotor, and
a rotor frame configured to receive the plurality of magnets, connected concentrically to the wheel, and configured to rotate inside the motor housing, and
wherein the fan is provided at the rotor frame.

8. The robot wheel driving apparatus of claim 7, wherein the rotor frame includes a rotational shaft provided in a central direction of the motor, and
wherein the rotational shaft includes:
a first rotational shaft portion supported by a first bearing, and
a second rotational shaft portion having a diameter greater than a diameter of the first rotational shaft portion, connected to a rear end of the first rotational shaft portion, and supported by a second bearing.

9. The robot wheel driving apparatus of claim 7, wherein the rotor frame includes:
a rotational shaft provided in a central direction of the motor,
a disk-shaped first rotor frame portion connected to the rotational shaft, and
a circular tube-shaped second rotor frame portion protruding to a predetermined length from an edge of the first rotor frame portion, and
wherein the fan is provided at the first rotor frame portion.

10. The robot wheel driving apparatus of claim 7, wherein the rotor frame includes:
a rotational shaft provided in a central direction of the motor,
a disk-shaped first rotor frame portion connected to the rotational shaft, and
a circular tube-shaped second rotor frame portion protruding to a predetermined length from an edge of the first rotor frame portion,
wherein the first rotor frame portion includes:
a disk-shaped outer frame,
a disk-shaped inner frame connected to the outer frame with a step therebetween, a distance between the outer frame and a center of the motor in a radial direction being greater than a distance between the inner frame and the center of the motor in the radial direction, and
an inclined frame connecting the outer frame to the inner frame, and wherein the fan includes:
a first fan provided at the inner frame and configured to reduce a temperature of the aluminum electrolytic capacitor, and
a second fan provided at the inclined frame and configured to reduce the temperature of the aluminum electrolytic capacitor.

11. The robot wheel driving apparatus of claim 10, wherein at least a part of the aluminum electrolytic capacitor is accommodated in an empty space inside the motor and provided between the first fan and the second fan,
wherein the aluminum electrolytic capacitor and the first fan are separated by a first gap portion, and
wherein the aluminum electrolytic capacitor and the second fan are separated by a second gap portion.

12. The robot wheel driving apparatus of claim 7, wherein the rotor frame includes:
a rotational shaft provided in a central direction of the motor,
a disk-shaped first rotor frame portion connected to the rotational shaft, and
a circular tube-shaped second rotor frame portion protruding to a predetermined length from an edge of the first rotor frame portion,
wherein the fan is provided at the first rotor frame portion, and
wherein the first rotor frame portion defines a plurality of holes in a thickness direction, the plurality of holes not being defined in areas of the first rotor frame portion facing the fan.

13. The robot wheel driving apparatus of claim 1, further comprising a printed circuit board (PCB) provided inside the inverter cover and facing the motor,
wherein the motor includes:
a stator disposed in the motor housing,
a rotor disposed at an outside of the stator, separated from the stator by an air gap, and configured to rotate with respect to the stator, and
a fan configured to reduce a temperature of the aluminum electrolytic capacitor,
wherein the stator includes:
a plurality of coils disposed in a circumferential direction,
a stator core on which the plurality of coils are wound and mounted, and
a stator frame supporting the stator,
wherein a first surface of the stator frame is coupled to the motor housing and covers the open surface of the motor housing,
wherein the inverter cover covers and couples to a second surface of the stator frame, and
wherein the PCB is coupled to the stator frame and disposed inside the inverter cover.

14. The robot wheel driving apparatus of claim 13, wherein the stator frame includes:
a first stator frame portion protruding circularly toward a center of the motor,
a second stator frame portion protruding circularly and spaced apart from the first stator frame portion in a radial direction, and
a third stator frame portion radially connecting the first stator frame portion to the second stator frame portion,
wherein the PCB is coupled to the second stator frame portion, and
wherein the aluminum electrolytic capacitor and the third stator frame portion are separated by a third gap portion.

15. A robot wheel driving apparatus comprising:
a wheel configured to rotate with a tire coupled thereto and move a robot;
a wheel cover connected to the wheel and covering both sides of the wheel;
a lower cover coupled to a lower portion of the wheel cover and configured to, based on the wheel being connected to the wheel cover, cover an open portion between the tire and the wheel cover;
a motor housing provided inside the wheel and having a cylindrical shape, the motor housing defining an open surface;
a motor inserted into the motor housing and configured to provide a rotational force to the wheel;
an inverter cover connected to the motor and covering the open surface of the motor housing;
an aluminum electrolytic capacitor protruding from an inside of the inverter cover in a direction opposite to the inverter cover, at least a part of the aluminum electrolytic capacitor being accommodated in the motor; and
a printed circuit board (PCB) provided inside the inverter cover and facing the motor,
wherein the aluminum electrolytic capacitor is disposed on a first surface of the PCB, the first surface facing the motor and disposed between lateral surfaces of the PCB, and
wherein the aluminum electrolytic capacitor protrudes toward an empty space within the motor and disposed at a predetermined distance from a center of the motor in a radial direction.

16. The robot wheel driving apparatus of claim 15, wherein the wheel includes:
a disk-shaped first wheel body portion, and
a second wheel body portion protruding in a circular tube shape along an edge of the first wheel body portion and configured to receive the tire.

17. The robot wheel driving apparatus of claim 15, wherein the wheel cover includes:
a first wheel cover portion covering a first side of the wheel,
a second wheel cover portion facing the first wheel cover portion with the wheel interposed therebetween and covering a second side of the wheel, and
a leg connector connecting the first wheel cover portion and the second wheel cover portion to a robot body,
wherein the first wheel cover portion includes:
a first cover body having a convex shape to cover the first side of the wheel to secure a first internal space having a predetermined size between the first side of the wheel and the first cover body, and
a first connector extending from an upper end of the first cover body in a height direction and connecting the first cover body to the leg connector, and wherein the second wheel cover portion includes:
a second cover body having a convex shape to cover the second side of the wheel to secure a second internal space having a predetermined size between the second side of the wheel and the second cover body, and
a second connector extending from an upper end of the second cover body in the height direction and connecting the second cover body to the leg connector.

18. The robot wheel driving apparatus of claim 15, further comprising a link embedded in the wheel cover and connecting the motor to the wheel cover to limit a position of the motor,
wherein a first end of the link is coupled to the wheel cover and a second end of the link is coupled to the motor.

19. The robot wheel driving apparatus of claim 15, wherein an inner circumferential surface of the tire provides a fastening groove,
wherein an outer circumferential surface of a second wheel body portion provides a fastening protrusion inserted into the fastening groove, and
wherein the fastening protrusion includes:
a band-shaped first fastening protrusion surrounding the outer circumferential surface of the second wheel body portion in a circumferential direction, and
a second fastening protrusion protruding in a direction intersecting the first fastening protrusion and provided in plurality that are spaced apart from each other at a predetermined distance.

20. The robot wheel driving apparatus of claim 15, wherein the motor includes:
a stator disposed in the motor housing; and
a rotor disposed at an outside of the stator, separated from the stator by an air gap, and configured to rotate with respect to the stator,
wherein the rotor is coupled to the wheel, and
wherein the rotor comprises a fan configured to reduce a temperature of the aluminum electrolytic capacitor.
